(19) United States
(12) Patent Application Publication
(10) Pub. No.: US 2025/0315370 A1
(43) Pub. Date: Oct. 9, 2025

(54) STORAGE SYSTEM AND DATA REPLICATION METHOD IN STORAGE SYSTEM

(71) Applicant: Hitachi Vantara, Ltd., Yokohama-shi (JP)

(72) Inventors: Yusuke YAMAGA, Tokyo (JP); Takaki MATSUSHITA, Tokyo (JP); Akira DEGUCHI, Tokyo (JP)

(73) Assignee: Hitachi Vantara, Ltd., Yokohama-shi (JP)

(21) Appl. No.: 18/829,910

(22) Filed: Sep. 10, 2024

(30) Foreign Application Priority Data
Apr. 5, 2024 (JP) 2024-061385

(51) Int. Cl. G06F 12/02

(52) U.S. Cl. CPC G06F 12/0223

(57) ABSTRACT

A storage system produces a data sharing volume that shares data stored in a replication source volume with a replication destination volume. The storage system copies the data stored in the replication source volume to the data sharing volume, and performs transfers that moves postscript data and meta information that are stored in a data sharing cache area of the replication source volume to a data sharing cache area of the data sharing volume. Then, the storage system copies the data stored in the replication source volume to the replication destination volume.

### BACKGROUND OF THE INVENTION

### 1. Field of the Invention

The present invention relates to a storage system and a data replication method in the storage system.

### 2. Description of the Related Art

In recent years, there is an increasing need for data utilization and an increasing number of opportunities for data replication. As a result, a volume replication function becomes more important in a storage system. Conventionally, there is a Redirect on Write (RoW) method as a representative implementation means of the volume replication function (see, for example, JP 2022-26812 A). Because there is no data copy during input/output (I/O), the ROW method has an advantage that an influence on I/O performance is small. The ROW method is often adopted in all flash array (AFA) devices.

The ROW method is a method for additionally writing data. The additional writing is a data storage method in which, when data is written in the storage system, the write data is stored in a new area without overwriting old data stored before the writing, and meta information is rewritten so as to refer to the data stored in the new area. When the replication of a certain volume is produced, the meta information about a replication source volume at that time is copied for a replication destination, and a replication destination volume can access the same data as the replication source volume by referring to the copied meta information. At the time of the volume replication, because only the meta information is copied while data is not copied, the replication destination volume can instantaneously be produced. For this reason, the data of the replication source volume accessed by the replication destination volume is stored in an area managed by the replication source volume.

### SUMMARY OF THE INVENTION

When the replication destination volume is produced from the replication source volume to perform development or test using data of the replication destination volume, sometimes old data of the replication source volume becomes unnecessary. Naturally, when the volume becomes unnecessary, a volume deletion operation is performed to release the data held by a deletion target volume from the storage system. However, in the related art, because the data referred to by the replication destination volume is also stored in the area managed by the replication source volume, there is a problem that the replication source volume cannot be deleted even when the data of the replication source volume is not required and the unnecessary data cannot be released from the storage system.

The present invention has been made in view of the above problems, and it is an object of the present invention to implement common of I/O performance, operation performance, and usability of the volume replication function in the storage system.

In order to achieve the above object, the present invention is a storage system providing a plurality of logical volumes includes a plurality of controllers, in which each of the logical volumes includes a first cache area that stores data and a second cache area that compresses and stores the data stored in the first cache area, and when the controller replicates the logical volume, data stored in the second cache area of a replication source logical volume is moved to the second cache area of a data sharing logical volume and data in the first cache area of the replication source logical volume is associated with the data moved to the second cache area of the data sharing logical volume, and a storage area of the first cache area of a replication destination logical volume that is a replication of the replication source logical volume is associated with a storage area that is the second cache area of the data sharing logical volume and stores the data.

According to the present invention, the common of the I/O performance, the operation performance, and the usability of the volume duplication function in the storage system can be implemented.

### BRIEF DESCRIPTION OF THE DRAWINGS

FIG. 1 is a view illustrating a configuration example of an entire system including a storage system according to a first embodiment;

FIG. 2 is a view illustrating an example of a logical configuration in the storage system according to the first embodiment;

FIG. 3 is a view illustrating a detailed example of a logical configuration in the storage system according to the first embodiment;

FIG. 4 is a view illustrating a problem of the prior art 1;

FIG. 5 is a view illustrating an example of a configuration of a memory of the first embodiment, and a program and management information in the memory;

FIG. 6 is a configuration diagram illustrating an example of a volume management table;

FIG. 7 is a view illustrating a configuration example of a cache area management table;

FIG. 8 is a view illustrating a configuration example of a directory table;

FIG. 9 is a view illustrating a configuration example of a mapping table;

FIG. 10 is a view illustrating a configuration example of a directory area allocation management table;

FIG. 11 is a view illustrating a configuration example of a replication volume generation management table;

FIG. 12 is a view illustrating a configuration example of a page conversion table;

FIG. 13 is a view illustrating a configuration example of a page allocation management table;

FIG. 14 is a view illustrating a configuration example of a sub-block management table;

FIG. 15 is a flowchart illustrating a processing procedure of volume production processing according to the first embodiment;

FIG. 16 is a flowchart illustrating a processing procedure of volume replication processing according to the first embodiment;

FIG. 17 is a flowchart illustrating a processing procedure of directory copy processing according to the first embodiment;

FIG. 18 is a flowchart illustrating a processing procedure of postscript processing according to the first embodiment;

FIG. 19 is a flowchart illustrating a processing procedure of read processing according to the first embodiment;

FIG. 20 is a flowchart illustrating a processing procedure of front end write processing according to the first embodiment;

FIG. 21 is a flowchart illustrating a processing procedure of a back end write processing according to the first embodiment;

FIG. 22 is a flowchart illustrating a processing procedure of volume deletion processing according to the first embodiment;

FIG. 23 is a flowchart illustrating a processing procedure of volume-related resource release processing according to the first embodiment;

FIG. 24A is a view illustrating a first effect of the first embodiment;

FIG. 24B is a view illustrating a second effect of the first embodiment;

FIG. 25 is a flowchart illustrating a processing procedure of volume replication processing according to a second embodiment;

FIG. 26 is a flowchart illustrating a processing procedure of read processing according to the second embodiment;

FIG. 27 is a flowchart illustrating a processing procedure of front end write processing according to the second embodiment; and

FIG. 28 is a flowchart illustrating a processing procedure of volume deletion processing according to second embodiment.

### DESCRIPTION OF THE PREFERRED EMBODIMENTS

In the following description, an “interface unit” may be at least one interface. The at least one interface may be at least one communication interface device of the same type (for example, at least one network interface card (NIC)), or may be at least two communication interface devices of different types (for example, an NIC and a host bus adapter (HBA)).

In the following description, a “memory unit” is at least one memory device, and may typically be a main storage device. At least one memory in the memory unit may be a volatile memory or a nonvolatile memory.

In the following description, a “PDEV unit” is at least one PDEV, and may typically be an auxiliary storage device. The “PDEV” means a physical storage device, and is typically a nonvolatile storage device such as a hard disk drive (HDD) or a solid state drive (SSD).

In the following description, a “storage unit” is at least one (typically, at least the memory unit) of the memory unit and at least a part of the PDEV unit.

In the following description, a “processor unit” is at least one processor device. Typically, the at least one processor device is a microprocessor device such as a central processing unit (CPU), and may be another type of processor device such as a graphics processing unit (GPU). The at least one processor device may be a single core or a multi-core.

Furthermore, the at least one processor device may be a processor device in a broad sense such as a hardware circuit (for example, a field-programmable gate array (FPGA) or an application specific integrated circuit (ASIC)) that performs some or all of processing.

In the following description, information from which output is obtained with respect to input will be described in an expression such as “xxx table”. However, the information may be data having any structure, or may be a learning model such as a neural network that generates output with respect to the input. Accordingly, the “xxx table” can be referred to as “xxx information”.

In the following description, the configuration of each table is an example, and one table may be divided into at least two tables, or all or a part of at least two tables may be one table.

In the following description, sometimes processing is described with a “program” as a subject. Because the program is executed by the processor unit to perform predetermined processing while appropriately using the storage unit and/or the interface unit, the subject of the processing may be the processor unit (or a device such as a controller having the processor unit).

The program may be installed in a device such as a computer, or for example, may be in a program distribution server or a recording medium readable (for example, non-transitory) by the computer. In the following description, at least two programs may be implemented as one program, or one program may be implemented as at least two programs.

In the following description, a “computer system” is a system including at least one physical computer. The physical computer may be a general-purpose computer or a dedicated computer. The physical computer may function as a computer (for example, a host computer) that issues an input/output (I/O) request, or may function as a computer (for example, a storage device) that performs I/O of data in response to the I/O request.

That is, the computer system may be at least one of a host system that is at least one host computer that issues the I/O request and a storage system that is at least one storage device that performs the I/O of data in response to the I/O request. At least one virtual computer (for example, a virtual machine (VM)) may be executed in the at least one physical computer. The virtual computer may be a computer that issues the I/O request or a computer that performs the I/O of data in response to the I/O request.

In addition, the computer system may be a distributed system including at least one (typically, a plurality of) physical node devices. The physical node device is the physical computer.

Furthermore, when the physical computer (for example, a node device) executes predetermined software, software-defined anything (SDx) may be constructed in the physical computer or the computer system including the physical computer. For example, a software defined storage (SDS) or a software-defined datacenter (SDDC) may be adopted as the SDx.

For example, the storage system as the SDS may be constructed by executing software having a storage function using a physical general-purpose computer.

In addition, at least one physical computer (for example, the storage device) may be executed by at least one virtual computer as a host system and a virtual computer as a storage controller of the storage system. The storage controller is typically a device that inputs and outputs data to and from the PDEV unit in response to the I/O request.

In other words, such at least one physical computer may have both a function as at least a part of the host system and a function as at least a part of the storage system.

In addition, the computer system (typically, the storage system) may have a redundant configuration group. The redundant configuration may be configured by a plurality of node devices such as Erasure Coding, Redundant Array of Independent Nodes (RAIN), and mirroring between nodes, or may be configured by a single computer (for example, a node device) such as at least one redundant array of independent (inexpensive) disks (RAID) groups as at least a part of the PDEV unit.

Furthermore, in the following description, a “data set” is a lump of logical electronic data viewed from a program such as an application program, and for example, may be any of a record, a file, a key value pair, and a tuple.

In addition, in the following description, an identification number is used as identification information of various targets, but identification information of a type (for example, an identifier including an alphabetic character or a code) other than the identification number may be adopted.

In the following description, a reference sign (or a common sign in the reference signs) may be used when the same type of elements are not distinguished from each other, and the identification number (or the reference sign) of the element may be used when the same type of elements are distinguished from each other.

For example, when “pages” that are units of storage areas are described without being particularly distinguished, they are described as “pages 312”. When the individual pages are distinguished and described, the individual pages may be described as “page #0”, “page #1”, and the like using page numbers, or described as “page 312-0”, “page 312-1”, and the like using reference numerals.

### First Embodiment

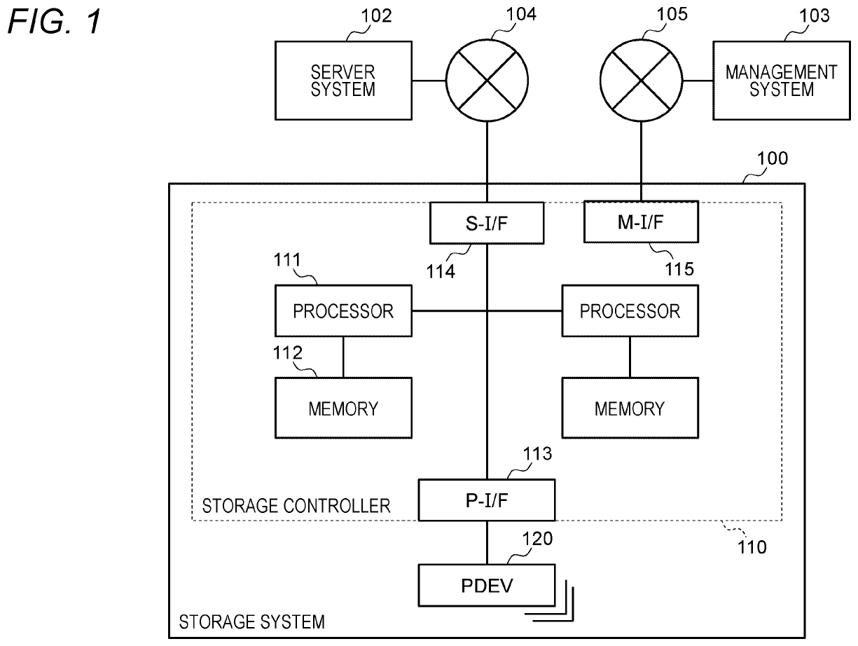

Hereinafter, a first embodiment of the present invention will be described in detail with reference to FIGS. 1 to 24.

FIG. 1 is a view illustrating a configuration example of an entire system including a storage system 100 according to the first embodiment. A storage system 100 includes a plurality of (or one) PDEVs 120 and a storage controller 110 connected to the PDEV 120.

The storage controller 110 includes an S-I/F 114, an M-I/F 115, a P-I/F 113, a memory 112, and a processor 111. The S-I/F 114, the M-I/F 115, and the P-I/F 113 are examples of the interface unit. The memory 112 is an example of the storage unit.

The S-I/F 114 is a communication interface device that mediates exchange of data between a server system 102 and the storage controller 110. The server system 102 is connected to the S-I/F 114 through a Fibre Channel (FC) network 104.

The server system 102 transmits an I/O request (a write request or a read request) designating an access destination (for example, a logical volume number such as a logical unit number (LUN) or a logical address such as a logical block address (LBA)) to the storage controller 110.

The M-I/F 115 is a communication interface device that mediates data exchange between a management system 103 and the storage controller 110. The management system 103 is connected to the M-I/F 115 through an Internet Protocol (IP) network 105. The network 104 and the network 105 may be the same communication network. The management system 103 manages the storage system 100.

The P-I/F 113 is a communication interface device that mediates data exchange between the plurality of PDEVs 120 and the storage controller 110. The plurality of (or one) PDEVs 120 are connected to the P-I/F 113.

The memory 112 stores a program executed by the processor 111 and data used by the processor 111. The processor 111 executes the program stored in the memory 112. In the first embodiment, for example, a set of the memory 112 and the processor 111 is duplicated.

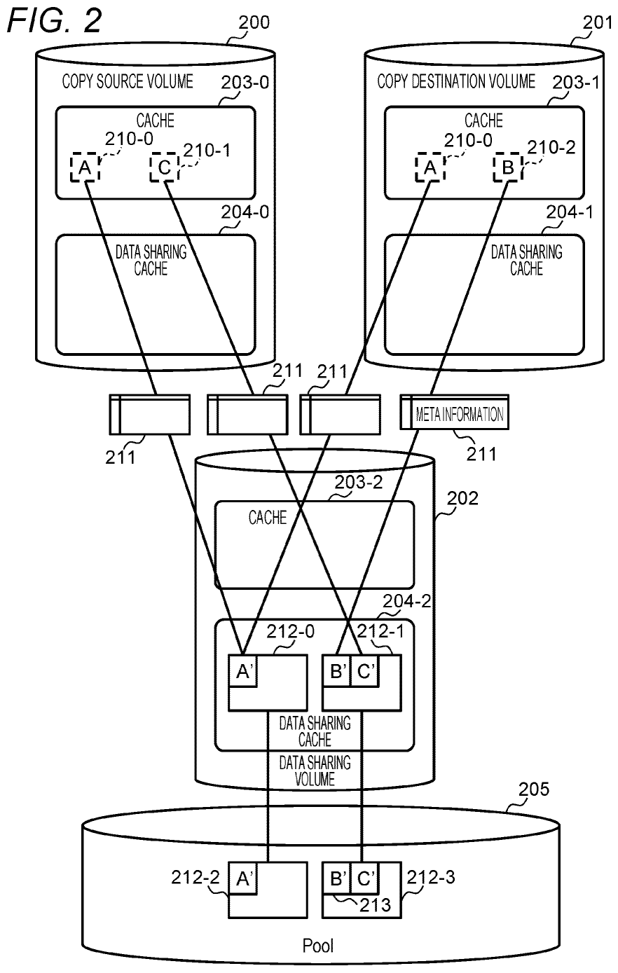

FIG. 2 is a view illustrating an example of a logical configuration in the storage system 100 of the first embodiment. The storage system 100 is a storage system that uses a redirect on write (RoW) method when operating a replication destination volume. The storage system 100 includes a replication source volume 200, a replication destination volume 201, a data sharing volume 202, and a pool 205 as logical configurations.

The replication source volume 200 is a logical volume provided to the host device (the server system 102 or the like). The replication source volume 200 stores write data, reads data, or transfers data to the host device based on read and write requests of the host device. The replication destination volume 201 is a replication volume of the replication source volume 200 produced by the volume replication function of the ROW method, and is provided to the host device. The replication destination volume 201 can also be read and written from the host device.

The data sharing volume 202 is the logical volume that stores data shared by the replication source volume 200 and the replication destination volume 201. One or a plurality of combinations of the replication source volume 200 and the replication destination volume 201 having a volume replication relationship are associated with one data sharing volume 202.

The pool 205 is a logical storage area based on at least one RAID group. The pool 205 includes a plurality of pages 212-i (i=0, 1, . . . n−1). In addition, the RAID group is a space of the RAID group configured by a plurality of PDEVs 120.

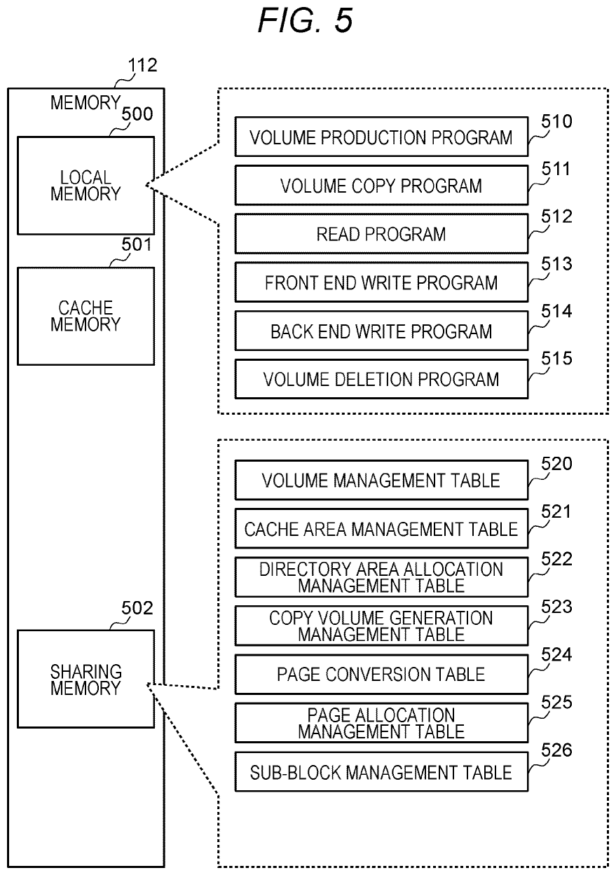

Each volume of the replication source volume 200 and the replication destination volume 201 has a cache area 203 and a data sharing cache area 204, respectively. The cache area 203 is a cache area in which data is written by a front end write program 513 (FIG. 5) described later and which temporarily holds data. The data sharing cache area 204 is a cache area that stores data in the cache area 203 again after the data is compressed by a back end write program 514 (FIG. 5) described later. The data sharing cache area 204 is referred to by the replication destination volume 201 or the like to share data among a plurality of volumes.

Hereinafter, an example of writing to the replication source volume 200 will be described.

When receiving the write request from the server system 102, the storage controller 110 compresses a data set C that is a write target. Then, the storage controller 110 post-scribes a data set C′ in which the data set C is compressed in a page 212-1 allocated to the data sharing volume 202 corresponding to the replication source volume 200.

In the first embodiment, the data sets A′, B′, C′, and D′ in FIGS. 2, 3, and 4 are examples of postscript data related to update of the data stored in the logical volume.

A page 212 is allocated from the pool 205 to the data sharing volume 202. A total capacity of the allocated page 212 is the capacity used in the storage system 100. That is, the page 212 is the page 212 allocated to the data sharing volume 202 corresponding to the replication source volume 200, in other words, the page 212 indirectly allocated to the replication source volume 200.

In the page 212-1, the compressed data set C′ is stored in a postscript manner. The page allocated to the data sharing volume 202 (the page indirectly allocated to the replication source volume 200) can be referred to as a “shared page”.

In the page 212-1, an area occupied by the compressed data set C′ will be referred to as a “sub-block 213” in the following description. In the page 212, a plurality of sub-blocks 213 are stored. The read processing and the write processing by the read and write requests from the server system 102 are performed in units of sub-blocks. When all the sub-blocks 213 in the page 212 are unnecessary invalid data, the capacity of the storage system 100 can be secured by releasing the storage area in units of pages.

The meta information 211 is a table that manages a storage destination address of the sub-block 213 in the shared page corresponding to a logical data block 210 of the replication source volume 200 or the replication destination volume 201. The meta information 211 is stored in a meta information area in the data sharing cache area 204. After the postscript of the compressed data set C′, the reference destination address of the meta information 211 corresponding to the logical address of a logical data block “C” 210-1 is updated to the postscript destination address of the compressed data set C′ in a shared page 212-1. Consequently, the data written in the replication source volume 200 can be managed.

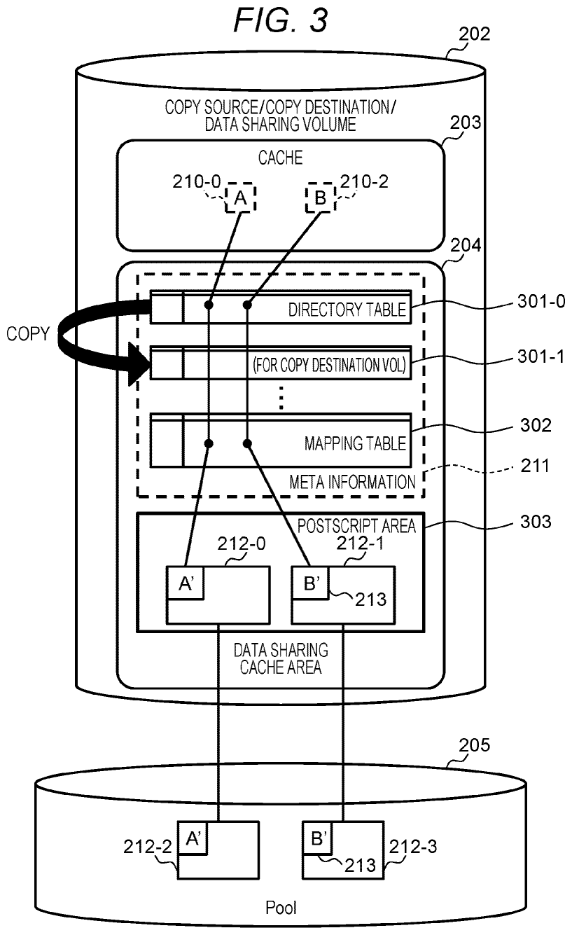

FIG. 3 is a view illustrating a detailed example of a logical configuration in the storage system 100 of the first embodiment. FIG. 3 illustrates the example of the logical configuration in which the meta information 211 that manages the relationship between the logical data block 210 of the replication source volume 200 or the replication destination volume 201 and the storage destination address of the sub-block 213 in the shared page is described in detail.

The meta information 211 includes a directory table 301 and a mapping table 302. The directory table 301 and the mapping table 302 are stored in a head portion of the data sharing cache area 204. FIG. 3 illustrates a state in which a relationship of the logical data block 210 and the sub-block 213 in the shared page is closed in the same data sharing volume 202 and volume replication is not performed.

The directory table 301 is a table that converts an address in the cache area 203 of a logical data block 210-i (i=0, 1) into an address in the data sharing cache area 204 in which the mapping table 302 is stored.

The mapping table 302 is disposed between the directory table 301 and a postscript area 303. The mapping table 302 exists for each data sharing volume 202. The mapping table 302 is a table that converts an address in the mapping table 302 into an address in the postscript area 303.

In this manner, information necessary for accessing the postscript area 303 of the data sharing cache area 204 from the cache area 203 is managed with the directory table 301 as a first layer and the mapping table 302 as a second layer.

A plurality of directory tables 301 can be managed in the data sharing cache area 204. When a volume replication operation is performed, only the directory table 301 is copied for the replication destination volume, and a directory table 301-1 for the replication destination volume is also managed in the same data sharing cache area 204 and referred from the replication destination volume. Consequently, the logical data block 210-i (i=0, 1) of the replication destination volume 201 can access the sub-block 213 in the shared page 212-1 of the data sharing volume 202 through the directory table 301 and the mapping table 302.

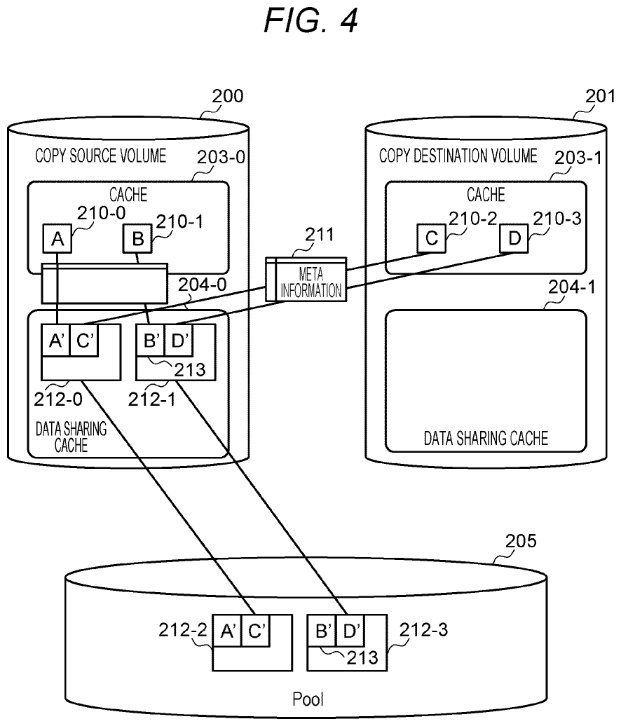

A problem of the prior art will be described with reference to FIG. 4. FIG. 4 is a view illustrating the problem of the prior art. FIG. 4 illustrates a configuration after the replication destination volume 201 is produced from the replication source volume 200 and the data set C210-2 and the data set D210-3 are written with respect to a data set A and a data set C duplicated to the replication destination volume 201.

During the volume replication, the directory table 301 that is the meta information 211 of the first layer is copied for the replication destination volume 201. For this reason, the replication destination volume 201 refers to the copied directory table 301 and refers to the sub-block 213 in a data sharing cache area 204-0 of the replication source volume 200 from the replication destination volume 201.

The replication source volume 200 provides a data set A210-0 and a data set B210-1 to the server system 102. In addition, the replication destination volume 201 provides a data set C210-2 and a data set D210-3 to the server system 102.

At this time, when the data set A210-0 and the data set B210-1 of the replication source volume 200 become unnecessary, the replication source volume 200 is deleted. By performing the deletion operation, it is desired to delete and release the data set A′ and the data set B′, which are the compressed data of the data set A210-0 and the data set B210-1, from the pool 205.

However, the data set C′ and a data set D′ of the replication destination volume 201 are also stored in the data sharing cache area 204 that is a management area of the replication source volume 200. For this reason, an operation for deleting the replication source volume 200 cannot be performed, and a problem that an unnecessary data set cannot be released from the storage system 100 is generated.

An embodiment for solving the above-described problems will be described with reference to FIGS. 5 to 24. FIG. 5 is a view illustrating an example of a configuration of the memory 112 of the first embodiment, and a program and management information in the memory 112.

The memory 112 includes memory areas called a local memory 500, a cache memory 501, and a shared memory 503. At least one of these memory areas may be an independent memory. The local memory 500 is used by the processor 111 belonging to the same set as the memory 112 including the local memory 500.

The local memory 500 stores a volume production program 510, a volume replication program 511, a read program 512, a front end write program 513, a back end write program 514, and a volume deletion program 515. These programs will be described later. The cache memory 501 temporarily stores the data set that is written to or read from the PDEV 120.

The shared memory 502 is used by both the processor 111 belonging to the same set as the memory 112 including the shared memory 502 and the processor 111 belonging to a different set. The shared memory 502 stores the management information. The management information includes a volume management table 520, a cache area management t table 521, a directory area allocation management table 522, and a replication volume generation management table 523. The management information includes a page conversion table 524, a page allocation management table 525, and a sub-block management table 526. These tables will be described later with reference to the drawings.

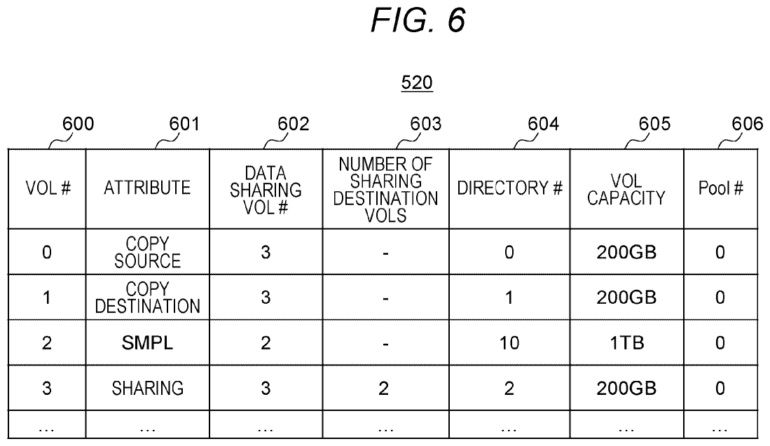

FIG. 6 is a view illustrating a configuration example of the volume management table 520. The volume management table 520 is a table that manages volumes such as the replication source volume 200, the replication destination volume 201, and the data sharing volume 202. The volume management table 520 includes a column of a VOL #600, an attribute 601, a data sharing VOL #602, a number of sharing destinations VOL 603, a directory #604, a VOL capacity 605, and a pool #606.

The VOL #600 is a number that identifies the volume. The attribute 601 is a type of volume identified by VOL #600, and includes “SMPL” indicating a replication source, a replication destination, and a VOL having no replication relationship or “sharing” that is a data sharing volume. The data sharing VOL #602 is a number that identifies the data sharing volume in which data of the replication destination volume or the replication source volume is stored. The number of sharing destination VOLs 603 is the total number of the replication source volume 200 and the replication destination volume 201 that refer to the data sharing volume 202 (or store data in the data sharing volume 202). The directory #604 is a number that identifies a directory table allocated to the replication source volume 200 or the replication destination volume 201. For example, in FIG. 6, the replication destination volume 201 with VOL #1 stores data in a volume with data sharing VOL #3, and 0 is allocated as the directory table #from the data sharing volume 202 with VOL #3.

The VOL capacity 605 is the capacity of the volume identified by the VOL #600. The pool #606 is a number of the pool from which the volume identified by VOL #600 is cut out.

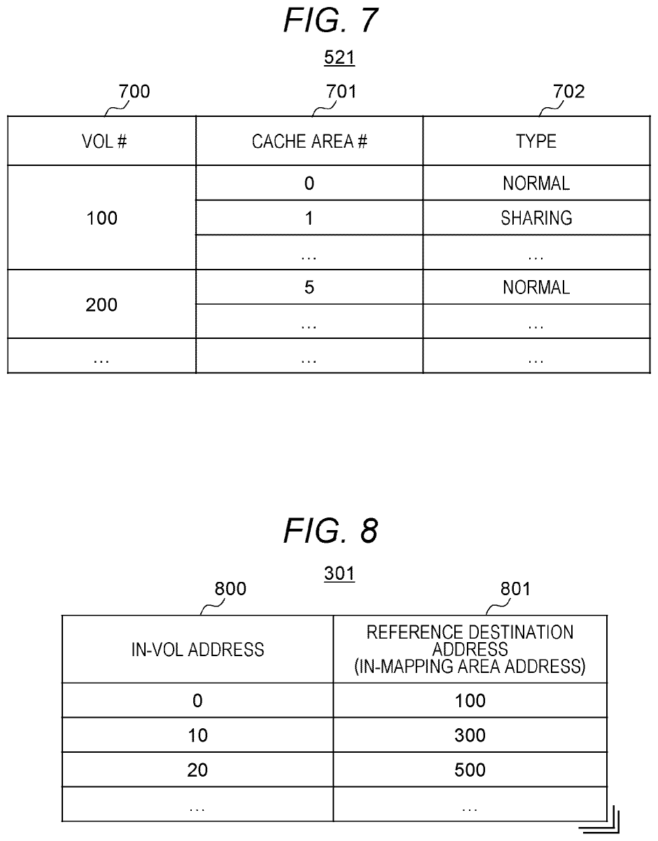

FIG. 7 is a view illustrating a configuration example of a cache area management table 521. The cache area management table 521 is a table that manages the cache area 203 and the data sharing cache area 204 that are used by volumes such as the replication source volume 200, the replication destination volume 201, and the data sharing volume 202. The cache area management table 521 includes a column of a VOL #700, a cache area #701, and a type 702.

The VOL #700 is a number that identifies the volume. The cache area #701 is a number that identifies the cache area used by the volume. In the type 702, the cache area identifies either the normal cache area 203 or the data sharing cache area 204. In the type 702, “sharing” is set in the case of the data sharing cache area 204, and “normal” is set in the case of the normal cache area 203.

FIG. 8 is a view illustrating a configuration example of a directory table 301-i (i=0, 1, 2). The directory table 301 for the replication source volume, the directory table 301 for the replication destination volume, and the directory table 301 for the data sharing volume have the same configuration. One entry of each directory table 301 corresponds to data in units of granularity (for example, 256 KB) of logical data of the replication source volume 200 and the replication destination volume 201.

The directory table 301 includes an in-VOL address 800 and a reference destination address (an in-mapping area address) 801. The in-VOL address 800 is a storage logical address of the target data in the replication source volume 200 in the case of a directory table 301-0 for the replication source volume 200. In addition, the in-VOL address 800 is the storage logical address of the target data in the replication destination volume 201 in the case of the directory table 301-1 for the replication destination volume 201.

The reference destination address (in-mapping area address) 801 is pointer information to the mapping table 302. The reference destination address (in-mapping area address) 801 corresponds to an in-mapping area address 900 of the mapping table 302 associated with the directory table 301.

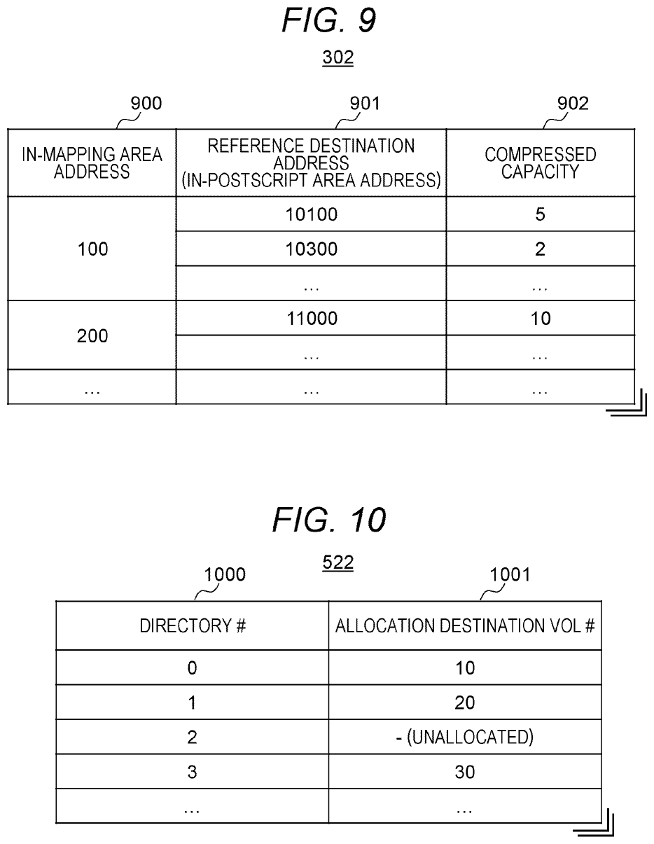

FIG. 9 is a view illustrating a configuration example of the mapping table 302. The mapping table 302 includes the in-mapping area address 900, a reference destination address (in-postscript area address) 901, and a compressed capacity 902.

The in-mapping area address 900 is the reference destination address (in-mapping area address) 801 of the directory table 301 associated with the mapping table 302. The reference destination address (in-postscript area address) 901 is an address in the postscript area 303 in which the target data is stored. The compressed capacity 902 is a data amount after compression when the target data of the replication source volume 200 or the replication destination volume 201 is stored in the postscript area 303.

FIG. 10 is a view illustrating a configuration example of the directory area allocation management table 522. The directory area allocation management table 522 is a table that manages the volume to which a directory #1000 is allocated in association with an allocation destination VOL #1001.

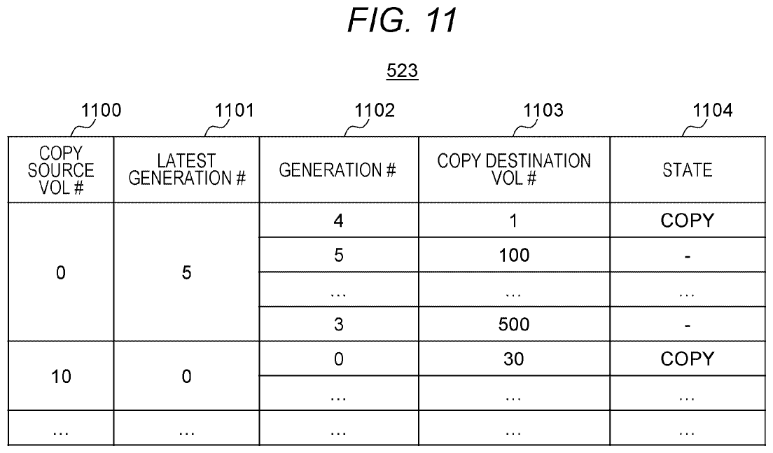

FIG. 11 is a view illustrating a configuration example of the replication volume generation management table 523. In the replication volume generation management table 523, the latest generation of the replication destination volume is managed for each replication source VOL #of the replication source volume 200. The replication volume generation management table 523 includes a replication source VOL #1100, a latest generation #1101, a generation #1102, a replication destination VOL #1103, and a state 1104. For example, the replication volume generation management table 523 manages 1024 generations for each replication source #VOL 1100 (generation #1102=0 to 1023).

In the replication volume generation management table 523, the latest generation #1101 is incremented every time a replication volume of each replication source VOL #1100 is produced, and the replication destination VOL #1103 corresponding to the latest generation #1101 and the state 1104 are updated. The state 1104 includes a copy state in which the replication destination volume is being produced (volume replication processing) and null after the completion of the volume replication processing.

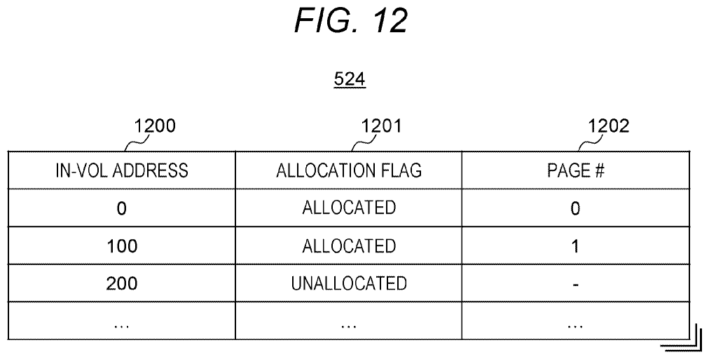

FIG. 12 is a view illustrating a configuration example of the page conversion table 524. The page conversion table 524 is set for each volume such as the replication source volume 200 and the data sharing volume 202. For example, the page conversion table 524 holds information regarding a relationship between the area (for example, page 212-0) in the data sharing volume 202 and the page 212-2.

For example, the page conversion table 524 includes the entry for each area in the data sharing volume 202. Each entry stores information such as an in-VOL address 1200, an allocation flag 1201, and a page #1202. Hereinafter, one area (referred to as a “target area”) will be described as an example.

The in-VOL address 1200 is information about the logical address (for example, a head logical address) of the target area. The allocation flag 1201 is information indicating whether the page 212-2 is allocated to the target area (“allocated”) or not (“unallocated”). The page #1202 is information about the number of the page 212-2 allocated to the target area.

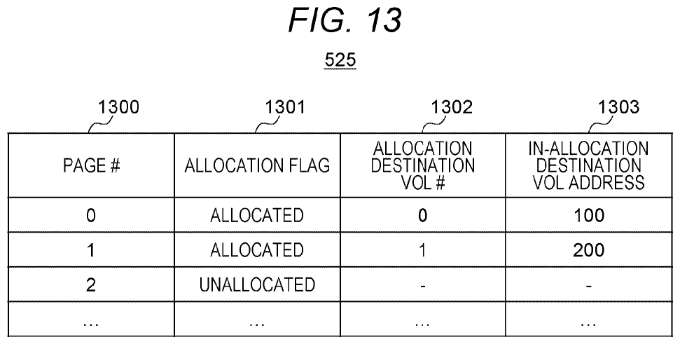

FIG. 13 is a view illustrating a configuration example of the page allocation management table 525. The page allocation management table 525 is set for each pool 205. The page allocation management table 525 holds information related to a relationship between the page 212-2 and an allocation destination thereof. For example, the page allocation management table 525 includes the entry for each page 212-2.

Each entry stores information such as a page #1300, an allocation flag 1301, an allocation destination VOL #1302, and an in-allocation destination VOL address 1303. Hereinafter, one page 212 (referred to as a “target page”) will be described as an example. The page #1300 is information about the number of the target page. The allocation flag 1301 is information indicating whether the target page is allocated (“allocated”) or not (“unallocated”).

The allocation destination VOL #1302 is information about the number of the allocation destination VOL (data sharing volume 202) of the target page. The in-allocation destination VOL address 1303 is information about the logical address (for example, the head logical address) of the area in the allocation destination VOL of the target page.

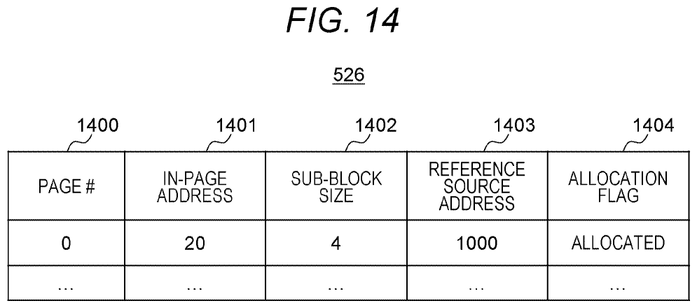

FIG. 14 is a view illustrating a configuration example of the sub-block management table 526. The sub-block management table 526 is set for each volume such as the replication source volume 200 and the data sharing volume 202. The sub-block management table 526 holds information related to the sub-block 213. For example, the sub-block management table 526 includes the entry for each sub-block 213.

Each entry stores information such as a page #1400, an in-page address 1401, a sub-block size 1402, a reference source address 1403, and an allocation flag 1404. Hereinafter, one sub-block 313 (referred to as a “target sub-block”) will be described as an example.

The page #1400 is information about the number of the page 212-0 including the target sub-block. The in-page address 1401 is information about the logical address of the target sub-block in the page 212-0. The sub-block size 1402 is information about a size of the target sub-block (the size of the compressed data set stored in the target sub-block).

The reference source address 1403 is address information that refers to the target sub-block. The reference source address of the sub-block 213 of the data sharing volume 202 in FIG. 3 is an address in the cache area 203 of the data sharing volume 202. The allocation flag 1404 is information indicating whether the target sub-block is (“allocated”) allocated or not (“unallocated”), in other words, whether the target sub-block is in use or unused.

### Volume Production Processing of First Embodiment

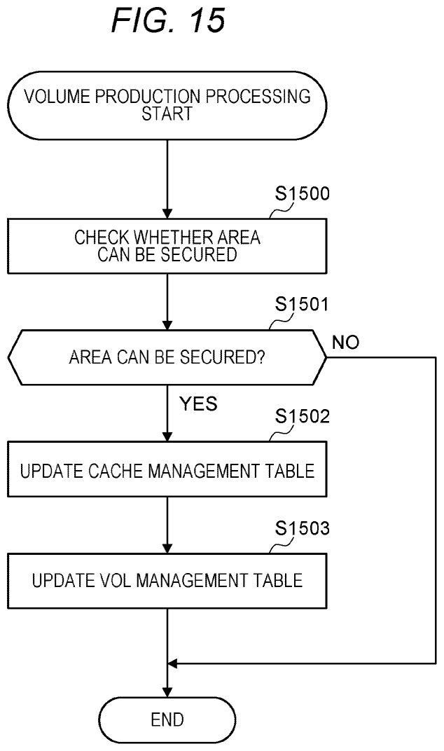

FIG. 15 is a flowchart illustrating a processing procedure of volume production processing according to the first embodiment. The volume production processing is executed by the volume production program 510 in response to the instruction from the management system 103.

First, in step S1500, the volume production program 510 checks whether the cache area 203 and the data sharing cache area 204 that satisfy the specification condition (capacity of volume or the like) remain in the storage system 100 (can be secured). When it is determined in step S1500 that the volume can be secured (Yes in step S1501), the volume production program 510 moves the processing to step S1502. On the other hand, the volume production program 510 ends the volume production processing when it is determined in step S1500 that the volume cannot be secured (No in step S1501).

Subsequently, in step S1502, the volume production program 510 allocates the cache area determined to be securable in step S1501 to the produced volume. In the cache area management table 521, the volume production program 510 updates the cache area #of the VOL #700 corresponding to the volume that is the production target to the secured cache area #, and sets the type 702 to either normal or sharing.

Subsequently, in step S1503, the volume production program 510 postscripts and updates the volume information including the attribute, the data sharing VOL #, the director #, the capacity, and the pool #produced by this volume production program to the volume management table 520.

### Volume Replication Processing of First Embodiment

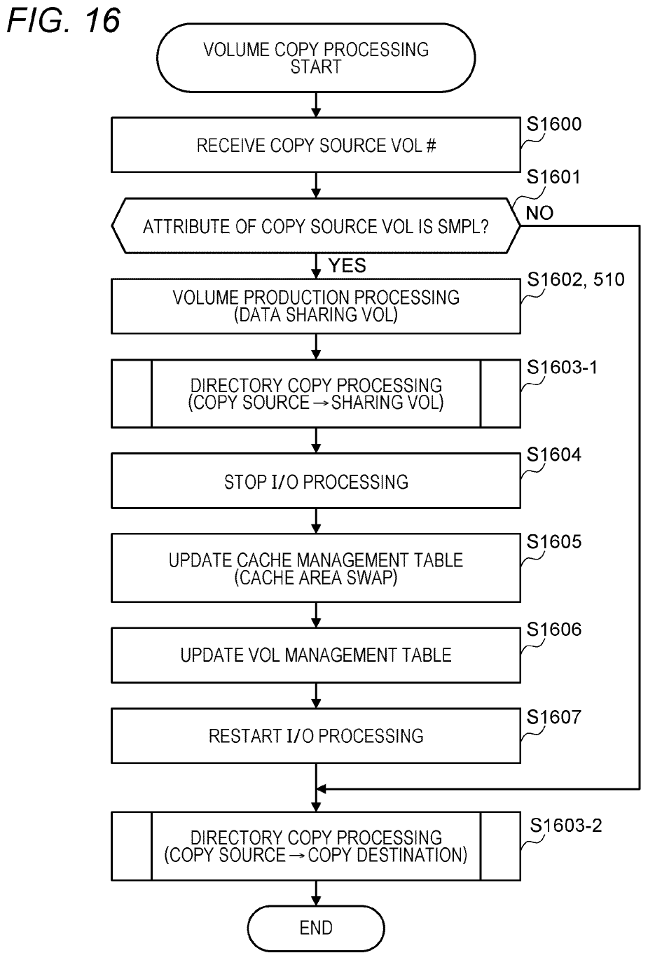

FIG. 16 is a flowchart illustrating a processing procedure of volume replication processing according to the first embodiment. The volume replication processing is processing of replicating the data of the replication source volume 200 to the replication destination volume 201. In the ROW method, user data is not copied, and the directory table 301-0 for the replication source volume that manages the data storage destination address is copied to the directory table 301-1 for the replication destination volume. The directory table 301-1 for the replication destination volume is referred to from the replication destination volume. Consequently, the data of the replication source volume 200 can be referred to, and it is possible to illustrate as if the data is copied to the replication destination volume 201. The volume replication processing is executed by a volume replication program 511-1 in response to the instruction from the management system 103.

First, in step S1600, the volume replication program 511-1 receives the replication source VOL #of the replication source volume 200. Subsequently, in step S1601, the volume replication program 511-1 refers to the volume management table 520 to check whether the attribute 601 corresponding to the replication source volume 200 is “SMPL” indicating that the volume replication operation is not performed even once. When the attribute of the replication source volume is SMPL (Yes in step S1601), the volume replication program 511-1 proceeds the processing to step S1602. On the other hand, when the attribute of the replication source volume 200 is not SMPL (No in step S1601), the volume replication program 511-1 proceeds the processing to 1603-2. The case where the attribute of the replication source volume 200 is not SMPL corresponds to the case of additional replication, and for example, the production of time-series snapshots can be cited.

In the processing after step $1602, processing of transferring the data sharing cache area 204 storing the data referred to by the replication source volume 200 and the replication destination volume 201 to the data sharing volume is performed in order to solve the problem of the prior art.

In step S1602, the volume replication program 511-1 produces the data sharing volume 202 that is the transfer destination of the data sharing cache area 204 using the volume production program 510. During the production of the data sharing volume, “sharing” is set to the attribute 601 of the volume management table 520 in the same manner as the volume of which VOL #600 is 3.

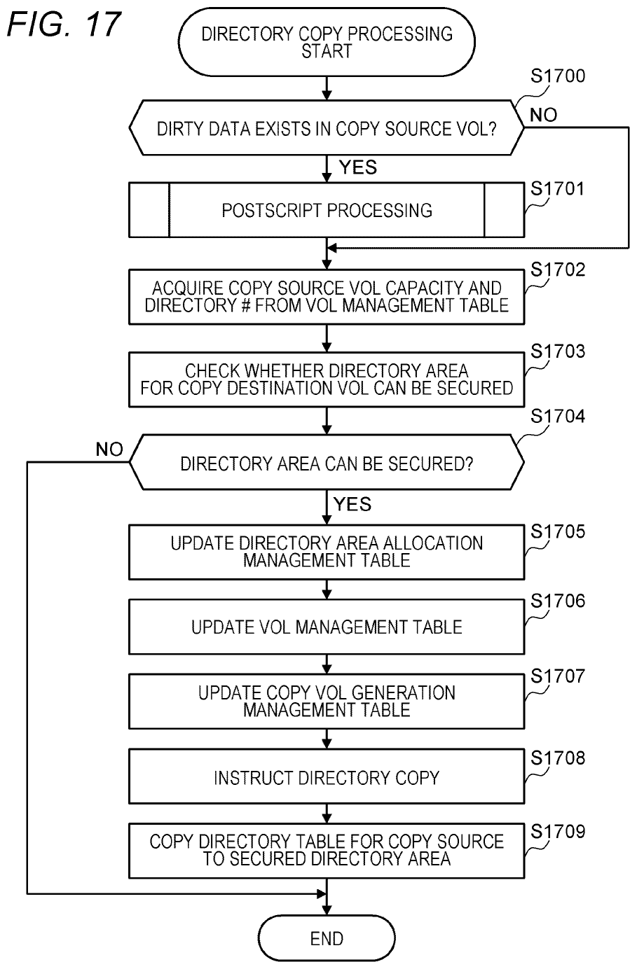

In step S1603-1, the volume replication program 511-1 copies the directory table 301 of the replication source volume to the directory table 301 secured for the data sharing volume. Details of step S1603-1 will be described later with reference to FIG. 17.

Subsequently, in step S1604, the volume replication program 511-1 temporarily stops the I/O processing in order to perform the replacement processing of the data sharing cache area 204 in next step S1605. Then, the volume replication program 511-1 prevents a read program 512-1 and the back end write program 514 that access the data sharing cache area 204 from operating.

Subsequently, in step S1605, the volume replication program 511-1 replaces a data sharing cache area 204-0 in which the data of the replication source volume 200 is stored with a data sharing cache area 204-2 of the data sharing volume. The volume replication program 511-1 updates the cache area #701 in which the type 702 is “sharing” and the type 702 in the cache area corresponding to the VOL #700 of the replication source volume 200 of the cache area management table 521 so as to be replaced. This replacement is performed between the cache area #701 in which the type 702 is “sharing” and the type 702 in the cache area corresponding to the VOL #700 of the data sharing volume 202. Consequently, the data sharing caches of the replication source volume 200 and the data sharing volume 202 are exchanged, and the data stored in the replication source volume 200 is transferred to the data sharing volume 202.

Because the data stored in the replication source volume 200 is moved to the data sharing volume 202 in step S1605, the data sharing cache area 204 of the data sharing volume 202 is required to be accessed during write or read the replication source volume 200. In step S1606, the volume replication program 511-1 updates the data sharing VOL #602 of the entry corresponding to the replication source volume 200 and the data sharing volume 202 of the volume management table 520 to VOL #600 of the data sharing volume.

In step S1607, because step S1605 and step S1606 that are processing related to cache area replacement are completed, the volume replication program 511-1 resumes the I/O processing stopped in step S1604. Finally, in step S1603-2, the volume replication program 511-1 copies the directory table 301 from the replication source volume 200 to the replication destination volume 201. Consequently, the data of the data sharing volume 202 referred to by the replication source volume 200 can be accessed from the replication destination volume 201.

### Directory Copy Processing of First Embodiment

FIG. 17 is a flowchart illustrating a processing procedure of directory copy processing according to the first embodiment. FIG. 17 illustrates details of each directory replication processing executed in steps S1603-1 and S1603-2 of FIG. 16. Hereinafter, as the directory replication processing executed in step S1603-1 of FIG. 16, the volume replication program 511-1 will be described as a processing subject.

First, in step S1700, the volume replication program 511-1 determines whether dirty data that is destaged in the replication source volume 200 that is a copy target exists in the cache area 203. When the dirty data that is not destaged to the replication source volume 200 exists (Yes in step S1700), the volume replication program 511-1 moves the processing to step S1701. On the other hand, when the dirty data does not exist (No in step S1700), the volume replication program 511-1 moves the processing to step S1702.

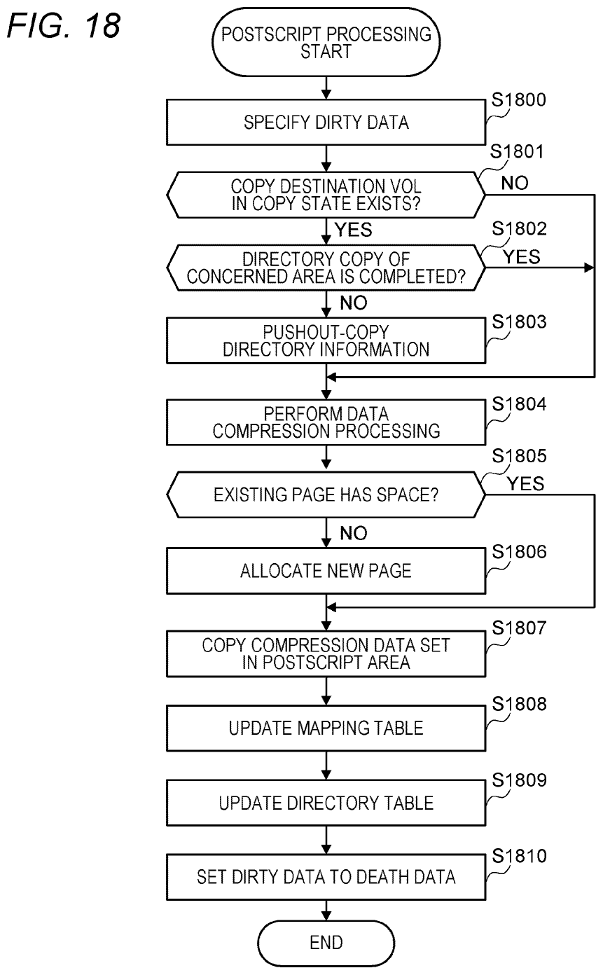

In step S1702, the volume replication program 511-1 performs processing of post-scribing the dirty data that is not reflected in the directory table 301 to bring the directory table 301 into the latest state. Details of step S1701 will be described later with reference to FIG. 18.

Subsequently, in step S1702, the volume replication program 511-1 acquires the capacity and the directory #of the replication source volume 200 from the volume management table 520. Subsequently, in step S1703, the volume replication program 511-1 checks whether the area of the directory table 301 for the replication destination volume, which is the replication of the replication source volume 200, can be secured in the replication source volume 200. The volume replication program 511-1 moves the processing to step S1705 when the area of the directory table 301 for the replication destination volume can be secured (Yes in step S1704), and ends the volume replication processing when the area cannot be secured (No in step S1704).

Subsequently, in step S1705, the volume replication program 511-1 refers to the directory area allocation management table 522 to allocate a directory #for the replication destination volume, and updates the allocation destination VOL #of the allocated directory #. Subsequently, in step S1706, the volume replication program 511-1 updates the information about the replication destination volume including the attribute, the data sharing VOL #, the directory #, the capacity, and the pool #that are produced in this volume replication processing to the volume management table 520. In addition, the volume replication program 511-1 increments the number of sharing destination VOLs 602 of the entry of the volume management table 520 corresponding to the data sharing volume 202 corresponding to the replication source volume 200. In step S1603-1 of FIG. 16, the volume replication program 511-1 increments the number of sharing destination VOLs 602 of the entry of the volume management table 520 corresponding to the replication source volume 200 itself.

Subsequently, in step S1707, the volume replication program 511-1 increments the latest generation #1101 corresponding to the replication source volume 200 by +1. In addition, the volume replication program 511-1 sets the replication destination VOL #1104 and the state 1104=copy, and updates the replication volume generation management table 523. The replication destination VOL #1104 corresponds to the VOL #of the volume management table 520.

Subsequently, in step S1708, the volume replication program 511-1 instructs the storage controller 110 to copy the directory. Subsequently, in step S1709, the volume replication program 511-1 receives the instruction of the directory copy in step S1708, and copies the directory table 301-0 of the replication source volume to the directory area secured in step S1705. The directory table 301-1 produced by the copy is referred to in the I/O processing of the produced replication destination volume.

### Postscript Processing of First Processing

FIG. 18 is a flowchart illustrating a processing procedure of postscript processing according to the first embodiment. The postscript processing is the following processing. That is, the data stored in the cache area 203 of the storage system by the front end write program 513 is compressed, transferred to the data sharing cache area 204, and post-scribed. Then, the directory table 301 and the mapping table 302 are updated so as to refer to the postscript data.

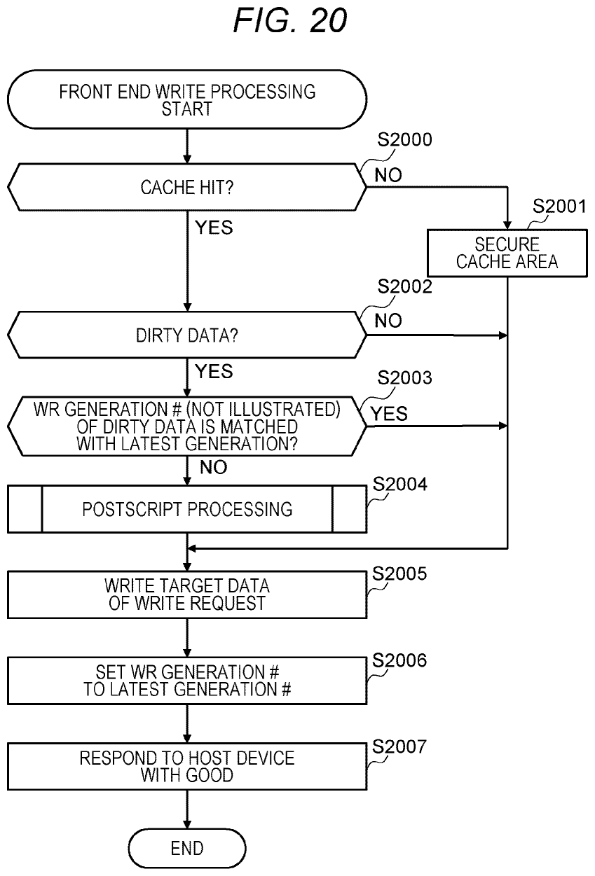

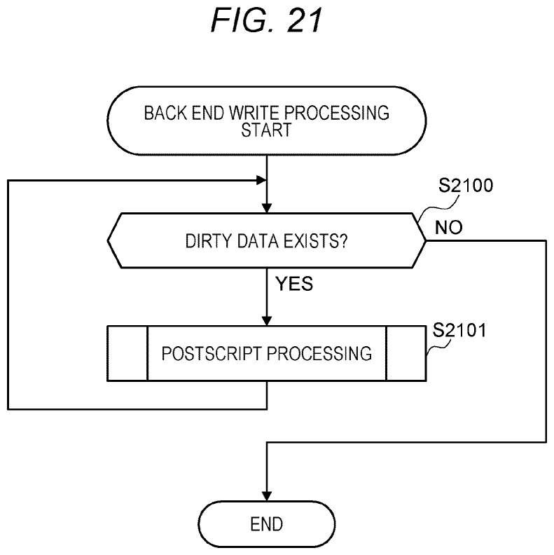

FIG. 18 illustrates details of each postscript processing executed in step S1701 of FIG. 17, step S2004 of FIG. 20, and step S2101 of FIG. 21. Hereinafter, as the postscript processing executed in step S1701 of FIG. 17, the volume replication program 511-1 will be described as the processing subject.

Each of the front end write program 513-1 in step S2004 of FIG. 20 and the back end write program 514 in step S2101 of FIG. 21 serves as the processing subject.

First, in step $1800, the volume replication program 511-1 specifies the dirty data. Subsequently, in step S1801, the volume replication program 511-1 refers to the replication volume generation management table 523 to determine whether the replication source volume 200 includes the replication destination volume 201 in the copy state. In the volume replication program 511-1, when the replication source volume 200 includes the replication destination volume 201 in the copy state, there is a possibility that another volume replication program 511-1 is operating to be performing the directory replication. For this reason, the processing proceeds to step S1802. When the replication destination volume 201 in which the replication source volume 200 is in the copy state does not exist (No in step S1801), the volume replication program 511-1 moves the processing to step S1804. On the other hand, when the replication destination volume 201 in which the replication source volume 200 is in the copy state exists (Yes in step S1801), the volume replication program 511-1 moves the processing to step S1802.

In step S1802, the volume replication program 511-1 determines whether the directory replication corresponding to the logical address (LBA) of the dirty data that is the postscript processing target is completed. When the postscript processing proceeds before the directory copy is completed, the directory table that is the copy target is updated by another volume replication program 511-1, the directory copy cannot be performed, and the volume replication cannot be performed. When the directory copy is completed (Yes in step S1802), the volume replication program 511-1 moves the processing to step S1804. On the other hand, when the directory copy is not completed (No in step S1802), the volume replication program 511-1 performs the copy by exporting the directory information about the area (step S1803). The exporting copy is processing of copying only the directory information about the postscript processing target area in a pinpoint manner when the postscript processing is performed on an uncopied area in the copy processing in step S1709 of FIG. 17.

Subsequently, in step S1804, the volume replication program 511-1 compresses the dirty data specified in step S1800. Subsequently, in step S1805, the volume replication program 511-1 determines whether a free space in a shared page 212-0 of the data sharing cache area 204 that is the transfer destination of the compressed data exists. The volume replication program 511-1 moves the processing to step S1807 when the free space exists (Yes in step S1805), and the volume replication program 511-1 allocates a new postscript page from the pool 205 when the free space does not exist (No in step S1805) (step S1806). Subsequently, in step S1807, the volume replication program 511-1 copies the compressed data set compressed in step S1804 to the postscript area 303 of the data sharing volume 202 corresponding to the replication source volume 200.

Subsequently, in step S1808, the volume replication program 511-1 holds the storage position in the writing area copied in step S1807 in the unused entry among the entries of the mapping table 302 of the data sharing volume 202. The unused entry is an entry in which the reference destination address (in-postscript area address) 901 is not set. That is, the replication destination postscript area address is set to the reference destination address (in-postscript area address) 901.

Subsequently, in step S1809, the volume replication program 511-1 sets the in-mapping area address 900 of the mapping information produced in step S1808 to the reference destination address (in-mapping area address) 801 of the directory table 301. The entry of the directory table 301 in which the in-mapping area address 900 is set is an entry corresponding to the logical address (LBA accessible from the host device) of the data.

Subsequently, in step S1810, the volume replication program 511-1 destages the dirty data copied to the postscript area in step S1807 and stores the data in the drive.

### Read Processing of First Embodiment

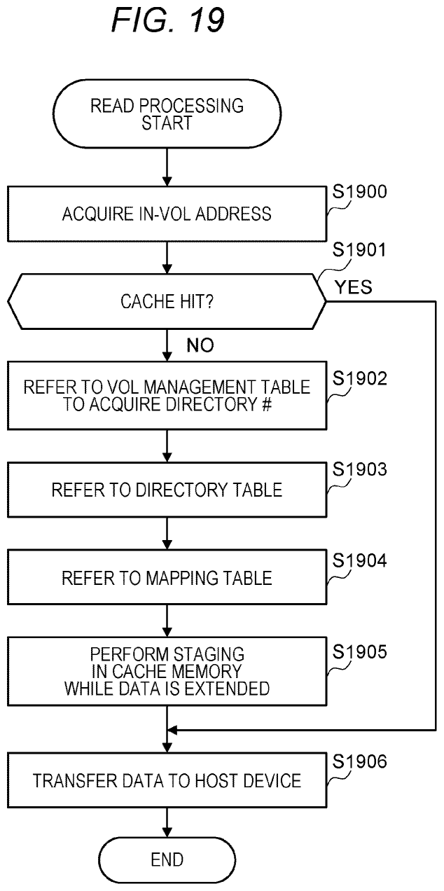

FIG. 19 is a flowchart illustrating a processing procedure of read processing according to the first embodiment. The read processing is executed by the read program 512-1 in response to the read request from the host device.

First, in step S1900, the read program 512-1 acquires the address in the replication source volume 200 or the replication destination volume 201 of data targeted by the read request from the server system 102. Subsequently, in step S1901, the read program 512-1 determines whether the target data of the read request is cache-hit. The read program 512-1 moves the processing to step S1905 when the target data of the read request is cache-hit (Yes in step S1901), and the read program 512-1 moves the processing to step S1902 when the target data of the read request is not cache-hit (No in step S1901).

Subsequently, in step S1902, the read program 512-1 refers to the volume management table 520 to acquire the directory #604 corresponding to the replication source volume 200 or the replication destination volume 201.

Subsequently, in step S1903, the read program 512-1 acquires the reference destination address (in-mapping area address) 801. The read program 512-1 acquires the reference destination address 801 based on the directory #604 acquired in step S1902 and the address in the replication source volume 200 or the replication destination volume 201 acquired in step S1900. When the target data of the read request is data in the replication source volume 200, the read program 512-1 refers to the directory table 301-0 for the replication source volume. When the data is in the replication destination volume 201, the read program 512-1 refers to the directory table 301-1 for the replication destination volume.

Subsequently, in step S1904, the read program 512-1 acquires the reference destination address (in-postscript area address) 901. The read program 512-1 refers to the mapping table 302 of the data sharing volume 202 to acquire the reference destination address 901 based on the reference destination address (in-mapping area address) acquired in step S1903.

Subsequently, in step S1905, the read program 512-1 stages the data stored in the in-postscript area address of the data sharing volume 202 specified in step S1904 in the cache area 203 while decompressing the data.

Subsequently, in step S1906, the read program 512-1 transfers the data that is cache-hit in step S1901 or the data staged in step S1905 to the host device.

### Front End Write Processing of First Embodiment

FIG. 20 is a flowchart illustrating a processing procedure of front end write processing according to first embodiment. The front end write processing is processing of writing the write data in the cache area 203 of the storage system in write request synchronization when the write request is received from the host device. On the other hand, the back end write processing described with reference to FIG. 21 is processing of transferring the write data (dirty data) on the cache area 203 to the postscript area 303 of the data sharing cache area to storing the write data in the drive. The front end write processing is executed by the front end write program 513-1 when the write request for the replication source volume 200 or the replication destination volume 201 is received from the host device.

First, in step S2000, the front end write program 513-1 determines whether the target data of the write request from the host device is cache-hit. The front end write program 513-1 moves the processing to step S2002 when the target data of the write request is cache-hit (Yes in step S2000), and the front end write program 513-1 moves the processing to step S2001 when the target data of the write request is not cache-hit (No in step S2000). In step S2001, the front end write program 513-1 secures the cache area in the cache memory 501.

In step S2002, the front end write program 513-1 determines whether the target data cache-hit in step S2000 is the dirty data. When the target data cache-hit in step S2000 is the dirty data (Yes in step S2002), the front end write program 513-1 moves the processing to step S2003. On the other hand, when being not the dirty data (No in step S2002), the front end write program 513-1 moves the processing to step 2005.

In step S2003, the front end write program 513-1 determines whether a wright (WR) generation #of the dirty data determined in step S2002 is matched with the generation #of the target data of the write request. The WR generation #is held in management information (not illustrated) about the cache data. In addition, the generation #of the target data of the write request is acquired from the latest generation #1101 in FIG. 11. In step S2003, the dirty data is updated with the target data of the write request while the postscript processing of the target data (dirty data) of the replication destination volume 201 replicated immediately before is not performed, and the data of the replication destination volume 201 is prevented from being overwritten. The front end write program 513-1 moves the processing to step S2005 when the WR generation #and the latest generation #are matched with each other (Yes in step S2003), and the front end write program 513-1 moves the processing to step S2004 when the WR generation #and the latest generation #are not matched with each other (No in step S2003).

In step S2004, the front end write program 513-1 executes the postscript processing described with reference to FIG. 18. In step S2004, the dirty data of the WR generation #that is not matched with the latest generation #is written to the postscript area and destaged from the cache memory 501.

In step S2005, the front end write program 513-1 performs the postscript processing on the cache area secured in step S2001 or the dirty data that requires postscript processing. Then, the front end write program 513-1 writes the target data of the write request to the cache area in which the dirty data can be generated again. In step S2005, when the data write to the cache area of the replication source logical volume after the production of the replication destination logical volume is the write that updates the data, the data after the update is stored while leaving the data before the update.

In step S2006, the front end write program 513-1 sets the WR generation #of the cache data written in the cache memory 501 in step S2005 to the latest generation #compared in step S2003. In step S2007, the front end write program 513-1 returns a normal response (good response) to the host apparatus.

FIG. 21 is a flowchart illustrating a processing procedure of back end write processing according to the first embodiment. When the data (dirty data) that is not reflected in the writing area 303 of the data sharing cache area 204 exists on the cache area 203, the back end write processing is processing of writing the data that is not reflected in the writing area 303. The back end write processing is performed in synchronization or asynchronization with the front end processing. The back end write processing is executed by the back end write program 514.

First, in step S2100, the back end write program 514 determines whether the dirty data exists on the cache area 203. The back end write program 514 moves the processing to step S2101 when the dirty data exists on the cache area 203 (Yes in step S2100), and the back end write program 514 ends the back end write processing when the dirty data does not exist (No in step S2100). In step S2101, the back end write program 514 executes the postscript processing described in FIG. 18.

### Volume Deletion Processing of First Embodiment

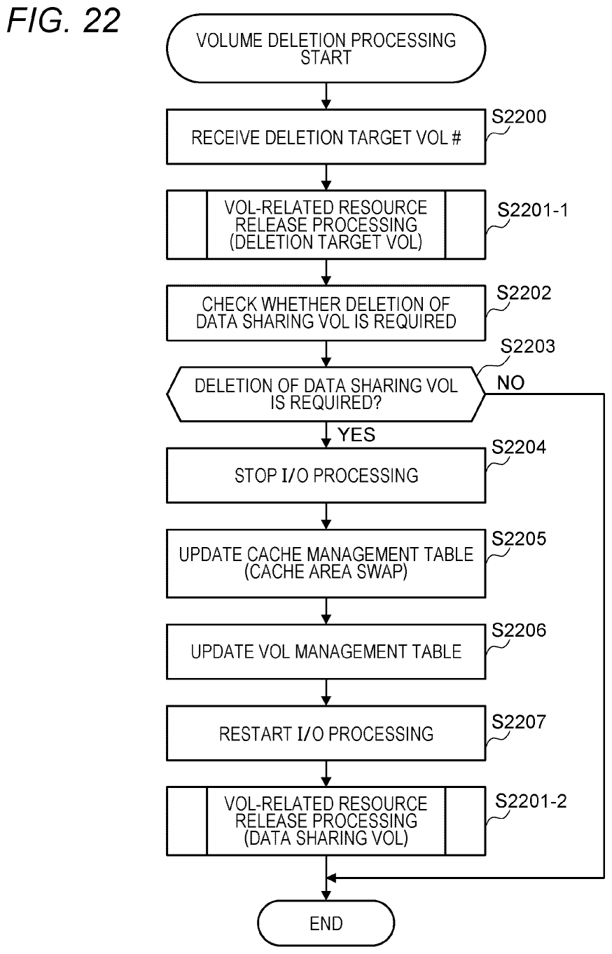

FIG. 22 is a flowchart illustrating a processing procedure of volume deletion processing according to the first embodiment. The volume deletion processing is executed by the volume deletion program 515-1 in response to the instruction from the management system 103.

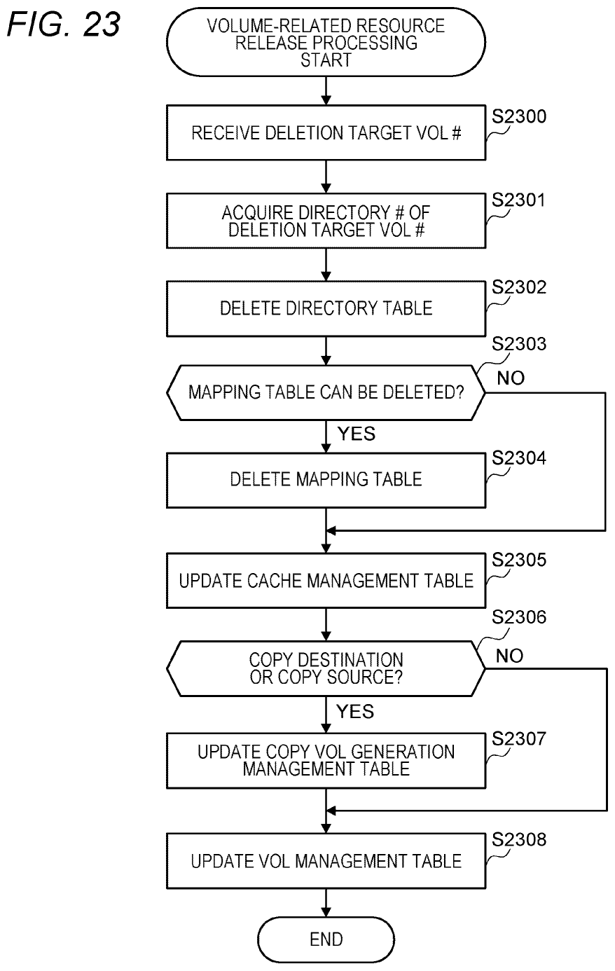

First, in step S2200, the volume deletion program 515-1 receives a deletion target VOL #that is a deletion target. Subsequently, in step S2201-1, the volume deletion program 515-1 performs processing of releasing a related resource related to a deletion target volume. Details of the related resource release processing will be described later with reference to FIG. 23.

After the deletion target volume is deleted in step S2201-1, it is determined in step S2022 whether the data sharing volume is also needed to be deleted. In step S2022, the volume deletion program 515-1 refers to the volume management table 520 to check whether the data sharing volume corresponding to the deletion target volume exists. When the data sharing volume 202 corresponding to the deletion target volume exists, the volume deletion program 515-1 checks whether the number of sharing destination VOLs of the data sharing volume 202 is 1. When the number of sharing destination VOLs of the data sharing volume is 1, because the replication source volume or replication destination volume that refers to the data sharing volume during the I/O is 1, the data sharing volume that shares the data with a plurality of volumes is not required to be left. For this reason, in order to delete the data sharing volume, processing of returning the data sharing cache area 204 held by the data sharing volume to one replication source volume 200 or replication destination volume 201 is performed in the processing of step S2204 and subsequent steps.

In step S2204, the volume deletion program 515-1 temporarily stops the I/O processing in order to perform the replacement processing of the data sharing cache area 204 in the next step S2205. Then, the volume deletion program 515-1 prevents the read program 512-1 and the back end write program 514 that access the data sharing cache area 204 from operating.

Subsequently, in step S2205, the volume deletion program 515-1 replaces the last remaining data sharing cache area 204 of the replication source volume 200 or the replication destination volume 201 with the data sharing cache area 204 of the data sharing volume 202. The volume deletion program 515-1 replaces the cache area #701 and the type 702 of the last remaining volume and the cache area #701 and the type 702 corresponding to the VOL #of the data sharing volume 202 in the cache area management table 521. Consequently, the data sharing volume 202 and the data sharing cache area 204 of the last remaining volume are exchanged, and the data in which the last remaining replication source volume 200 or replication destination volume 201 is stored is transferred to the data sharing volume 202.

In step S2205, the data stored in the data sharing volume 202 is moved to the replication source volume 200 or replication destination volume 201 that remains last. For this reason, the data sharing cache of itself (the replication source volume 200 or the replication destination volume 201) is required to be accessed instead of the data sharing volume 202 during the write and read of the replication source volume 200 or the replication destination volume 201. In step S2206, the volume deletion program 515-1 updates the data sharing VOL #602 of the entry corresponding to the data sharing volume 202 to the VOL #600 of the entry corresponding to the last remaining volume in the volume management table 520.

Subsequently, in step S2207, because steps S2205 and S2206 that are processing related to the cache area replacement are completed, the volume deletion program 515-1 resumes the I/O processing stopped in step S2204. Finally, in step S2201-2, the volume deletion program 515 performs processing of releasing the related resource related to the unnecessary data sharing volume 202.

### Volume-Related Resource Release Processing of First Embodiment

FIG. 23 is a flowchart illustrating a processing procedure of volume-related resource release processing according to the first embodiment. FIG. 23 illustrates details of each volume-related resource release process executed in steps S2201-1 and S2201-2 of FIG. 22. Hereinafter, as the volume-related resource release process executed in step S2201-1 of FIG. 22, the volume deletion program 515 will be described as the processing subject.

First, in step S2300, the volume deletion program 515-1 receives the VOL #of the deletion target volume. Subsequently, in step S2301, the volume deletion program 515-1 acquires the directory of the deletion target volume from the volume management table 520. Subsequently, in step S2302, the volume deletion program 515-1 deletes the directory table 301 corresponding to the directory #acquired in step S2301.

Subsequently, in step S2303, the volume deletion program 515-1 determines whether the mapping table 302 can be deleted (that is, whether the deletion target volume is the volume not including the replication destination volume 201). When the mapping area can be deleted (Yes in step S2303, the deletion target volume does not include the replication destination volume 201), the volume deletion program 515-1 moves the processing to step S2304. On the other hand, when the mapping area cannot be deleted (No in S2303, the deletion target volume includes the replication destination volume 201), the volume deletion program 515-1 moves the processing to step S2305. In step S2304, the volume deletion program 515-1 deletes the mapping table 302 referred to from the directory table 301.

Subsequently, in step S2305, the volume deletion program 515-1 deletes the entries of the cache area #and the type 702 of the VOL #700 corresponding to the volume that is the deletion target. Then, the volume deletion program 515-1 releases the cache area 203 and the data sharing cache area 204 from the deletion target volume.

Subsequently, in step S2306, the volume deletion program 515-1 determines whether the deletion target volume is the replication source volume 200 or the replication destination volume 201 (that is, the volume having the replication relationship). When the deletion target volume is the replication source volume 200 or the replication destination volume 201 (Yes in step S2306), the volume deletion program 515-1 moves the processing to step S2307. On the other hand, when the deleted volume is the volume having no replication relationship (the attribute 601 of the volume management table 520 is “SMPL”) (No in step S2306), the volume deletion program 515-1 moves the processing to step S2308.

In step S2307, when the deletion target volume is the replication source volume 200, the volume deletion program 515-1 deletes a plurality of entries corresponding to the replication source VOL #1100 from the replication volume generation management table 523. On the other hand, when the deletion target volume is the replication destination volume 201, the volume deletion program 515-1 deletes only the entry in which the replication source VOL #1100 that is the deletion target is set among the entries corresponding to the replication source VOL #1103.

Finally, in step S2308, the volume deletion program 515-1 deletes the entry of the volume corresponding to the deletion target volume from the volume management table 520.

### Modification of First Processing

In the first embodiment, during the execution of the volume replication processing (FIG. 16), the postscript data in the postscript area 303 and the meta information 211 in the meta information region of the replication source volume 200 are transferred to the data sharing volume 202 (steps S1602 to S1607). However, the present invention is not limited thereto, and the transfer timing may be a volume operation such as the deletion of the replication source volume. In this case, steps S1602 to S1607 in FIG. 16 are executed during each of the volume deletion processing (FIG. 22) and the volume-related resource release processing (FIG. 23).

### Effects of First Processing

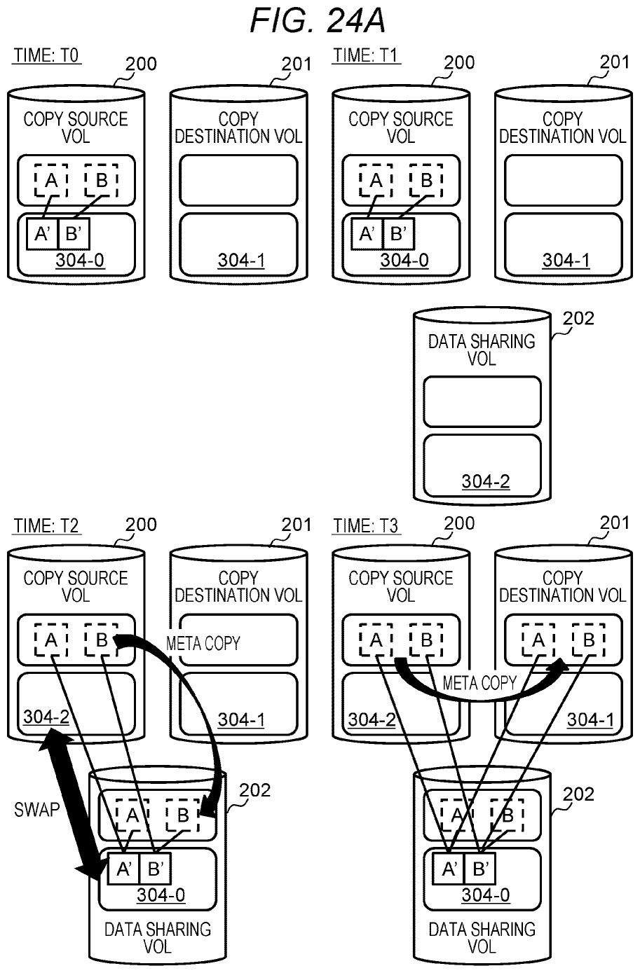

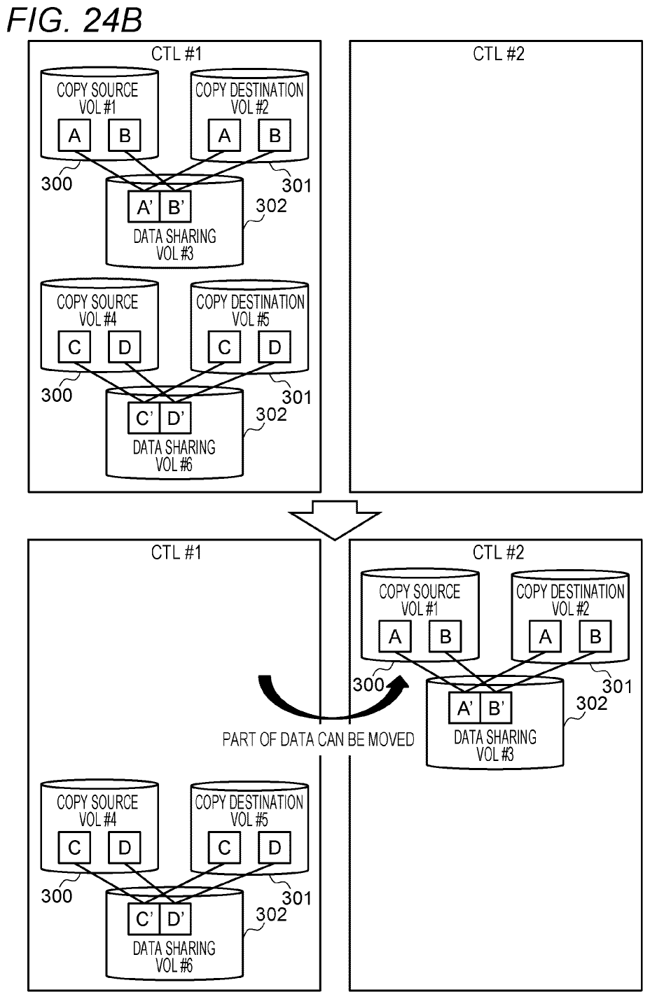

Subsequently, effects of the first processing will be described with reference to FIGS. 24A and 24B.

FIG. 24A illustrates a first effect of the first processing. FIG. 24A illustrates a logical configuration when the data of the replication source volume 200 is post-scripted to the replication destination volume 201 by the volume replication program 511-1, and illustrates the state in which the processing of the volume replication program 511-1 progresses as a time TO proceeds to a time T3.

When the volume replication operation is performed at the time T0, the volume deletion program 515 is a volume in the SMPL state in which the replication source volume 200 does not have the replication relationship. For this reason, the data sharing volume 202 that stores the data shared between the replication source and the replication destination volume is produced (time T1). Thereafter, at a time T2, the directory table 301-1 of the replication source volume 200 is copied to the directory table 301-2 for the data sharing volume. Then, a data sharing cache area 304-0 of the replication source volume 200 and a data sharing cache area 304-2 of the data sharing volume 202 are swapped. Consequently, the data shared by the replication source volume and the replication destination volume can be managed by the data sharing volume.

Thereafter, at the time T3, the volume deletion program 515 copies the directory table of the replication source volume to the directory table for the replication destination volume. Consequently, the data of the data sharing volume (the same data as the replication source volume) can be referred from the replication destination volume.

At the time T3, the data accessed by the replication source volume 200 and the replication destination volume 201 is stored in the data sharing volume 202. For this reason, both the volume deletion operation of the replication source volume and the volume deletion operation of the replication destination volume can be performed, and the unnecessary data of each volume can be released from the storage system 100.

FIG. 24B illustrates a second effect of the first processing. As illustrated in FIG. 24B, in the first embodiment, one data sharing volume 202 is produced for each volume group having the replication relationship between the replication source volume and the replication destination volume. So, in a multi-controller system in which the storage system 100 includes a plurality of storage controllers 110, movement between the storage controllers 110 can be performed in units of volume groups having the replication relationship. For example, when the I/O load of a replication source volume #1 increases and the load of a storage controller #1 (CTL #1) increases, other volumes such as a replication source volume #4 belonging to the storage controller #1 may also be affected. For this reason, the volume group having the replication relationship including the volume with the high load is moved to a storage controller #2 (CTL #2) with the low I/O load. Consequently, it is possible to reduce the unevenness of the I/O load between the storage controllers can be reduced to prevent the degradation of the storage system I/O performance.

### Second Embodiment

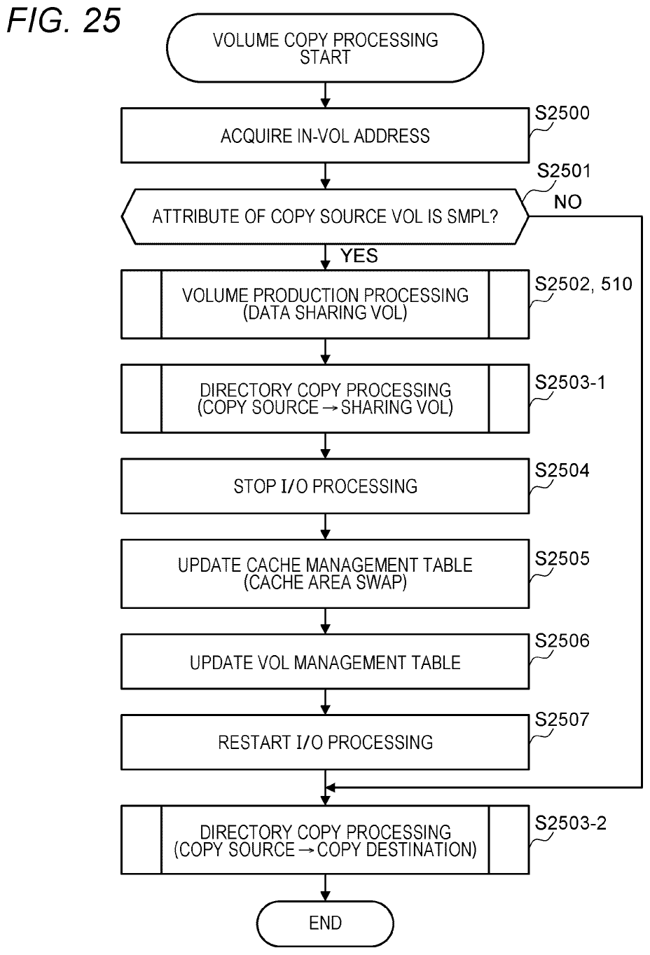

Hereinafter, a second embodiment of the present invention will be described with reference to FIGS. 25 to 28.

In the first embodiment, the data sharing cache area 204-0 of the replication source volume 200 and the data sharing cache area 204-2 of the data sharing volume are replaced during the first volume replication. In addition, when the replication source volume 200 or the replication destination volume 201 is deleted, in the case where the replication source volume 200 or the replication destination volume 201 is the last one, the last one volume is replaced with the data sharing cache area of the data sharing volume 202. A second embodiment is different in that both the cache area 203 and the data sharing cache area 204 are replaced with a set during the volume replication and the volume deletion.

### Volume Replication Processing of Second Embodiment

FIG. 25 is a flowchart illustrating a processing procedure of volume replication processing according to the second embodiment. The volume replication processing of the second embodiment is different from the first embodiment only in that steps S1605 and S1606 by the volume replication program 511-1 are changed to steps S2505 and S2506. Steps S2500, S2501, S2502, S2503, S2504, S2507 in FIG. 25 are the same as steps S1600, S1601, S1602, S1603, S1604, S1607 in FIG. 16, respectively.

In step S2505, the volume replication program 511-2 replaces the cache areas 203-0 and 203-2 and the data sharing cache areas 204-0 and 204-2 between the replication source volume 200 and the data sharing volume 202. In addition, the volume replication program 511-2 replaces and updates the cache area #701 and the type 702 corresponding to the VOL #of the replication source volume 200 and the data sharing volume 202 of the cache area management table 521.

Subsequently, in step S2506, the volume replication program 511-2 updates the volume management table 520. In the second embodiment, because the cache area 203 is also replaced, the directory #referred to by the replication source volume 200 and the data sharing volume 202 during I/O is required to be also replaced. The volume replication program 511-2 updates the data sharing VOL #602 of the entry corresponding to the replication source volume 200 and the data sharing volume 202 of the volume management table 520 to the VOL #600 of the data sharing volume. In addition, the volume replication program 511-2 updates the replication source volume 200 of the volume management table 520 and the directory #604 of the data sharing volume 202 such that the replication source volume 200 and the directory #604 are replaced. Step S2507 and subsequent steps are the same as step S1607 and subsequent steps in FIG. 16.

### Read Processing of Second Embodiment

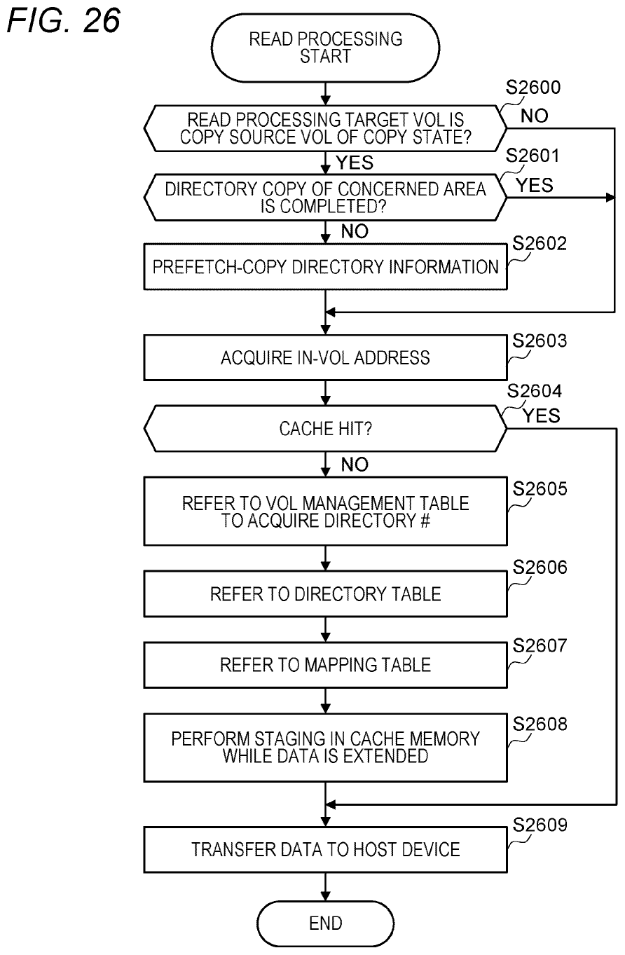

FIG. 26 is a flowchart illustrating a processing procedure of read processing according to the second embodiment. Compared to the first embodiment, steps S2600, S2601, S2602 are added.

In the second embodiment, the volume replication program 511-2 copies the directory table 301 from the replication source volume 200 to the data sharing volume 202 (step S2503-1). Then, the directory #is replaced together with the replacement of the data sharing cache area 204 (step S2506). So, the directory table 301 for the data sharing volume as the replication destination of the directory before the replacement is accessed during the I/O by the replication source volume 200 after the replacement. When the data is not written in the replication source volume 200 during the directory replication processing in step S2503-1, the directory table 301 of the replication source volume 200 and the data sharing volume 202 that is the copy destination is in the same state.

However, when the replication source volume 200 is written during the directory copy processing, the entry of the latest directory table 301 updated by the write processing cannot be copied to the directory table 301 for the data sharing volume that is the copy destination. Then, there is a possibility that the directory table 301 is in an old state. The directory table 301 may be copied again by the volume replication program 511-2, but when the write frequency is high, the copy is required to be performed a plurality of times, and the volume replication time becomes long. For this reason, the volume replication program 511-2 does not re-copy the latest directory table 301. That is, after the cache area and the directory #are replaced, the latest directory table is copied once by the read program 512-2 or the front-end write program 513-2. Consequently, the time required for the volume replication is shortened.

In the added processing, before the read processing of the replication source volume after the replacement of the directory #is performed, the read processing is performed after the information about the latest directory table is advance-copied.

Steps S2603, S2604, S2605, S2607, S2608, S2609 in FIG. 26 are the same as steps S1900, S1901, S1902, S1903, S1904, S1905, S1906 in FIG. 19.

First, in step S2600, the read program 512-2 refers to the replication volume generation management table 523 to determine whether the read processing target volume is the replication source volume 200 in the copy state. When the replication source volume 200 in the copy state, Because there is a possibility that the directory table 301 is not copied, the processing proceeds to step S2601. The read program 512-2 moves the processing to step S2601 when the volume is the replication destination volume in the copy state (Yes in step S2600), and the read program 512-2 moves the processing to step S2603 when the volume is the replication source volume in the copy state (No in step S2600).

Subsequently, in step S2601, the read program 512-2 determines whether the directory replication corresponding to the logical address (LBA) of the read processing target is completed. When the read processing proceeds before the directory replication is completed, the data in the old state is stored in the host device. When the directory replication is completed (Yes in step S2601), the read program 512-2 moves the processing to step S2603. On the other hand, when the directory replication is not completed (No in step S2601), the read program 512-2 advance-copies the directory information of the area (directory information advance-copy) (step S2602). The directory information advance-copy is processing of copying only the directory information of the read processing target area in a pinpoint manner when the read processing is performed on the uncopied area in the copy processing in step S1709 of FIG. 17. Step S2603 and the subsequent steps are the same as step S1900 and the subsequent steps in FIG. 19.

### Front End Write Processing of Second Embodiment

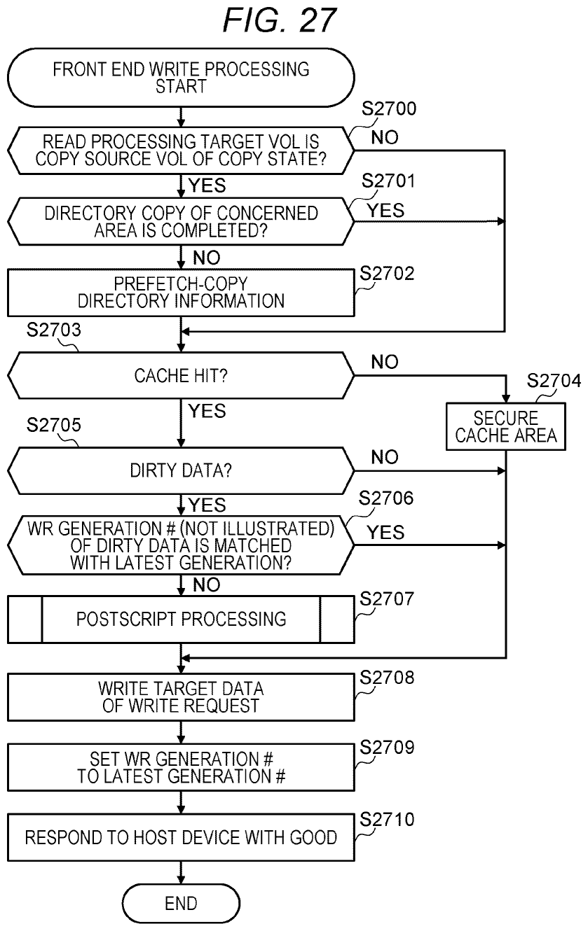

FIG. 27 is a flowchart illustrating a processing procedure of front-end write processing according to the second embodiment. Compared to the first embodiment, steps S2700, S2701, S2702 are added. Similarly to the read program 512-2, the front end write program 513-2 also advance-copies the latest information about the directory table 01 before the front end write processing of the replication source volume after the replacement of the directory #is performed in the added processing. For this reason, steps S2700 to S2702 in FIG. 27 are the same as steps S2600 to S2602 in FIG. 26, respectively. Steps S2703 to S2710 in FIG. 27 are the same as steps S2000 to S2007 in FIG. 20, respectively.

### Volume Deletion Processing of Second Embodiment

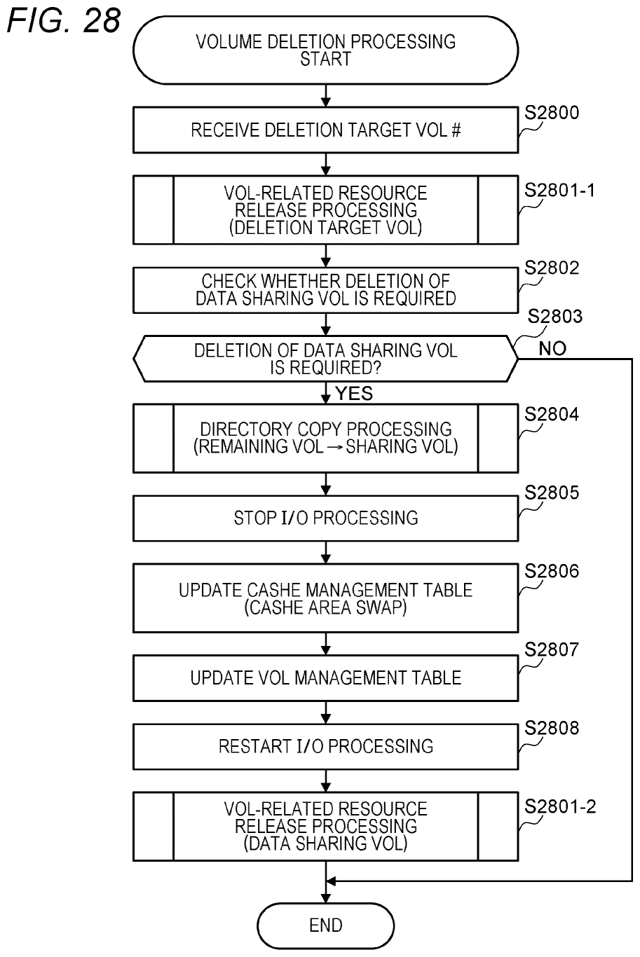

FIG. 28 is a flowchart illustrating a processing procedure of volume deletion process according to the second embodiment.

In the volume deletion processing of the second embodiment, step S2804 of the directory copy processing is added as compared with the first embodiment. In addition, steps S2205 and S2206 of the volume replication program 511-1 are changed to steps S2806 and S2807.

In the second embodiment, because the replacement of the directory #is also required along with the replacement of the cache area 203, the directory copy processing is required to be performed to update the volume deletion processing to the latest state.

Steps S2800, S2801, S2802, S2803, S2805, S2808 in FIG. 28 are the same as steps S2200, S2201, S2202, S2203, S2204, S2207 in FIG. 22.

In step S2804 subsequent to step S2803, the volume deletion program 515-2 copies the directory table corresponding to the last-remaining replication source or replication destination volume to the directory table corresponding to the data sharing volume, and updates the directory table to the latest state. Details of step S2803 are the same as those of step S1603 in FIG. 17.

In step S2806, the volume deletion program 515-2 replaces the cache area 203 and the data sharing cache area 204 between the data sharing volume 202 and the last-remaining replication source volume 200 or replication destination volume 201. In addition, in the cache area management table 521, the volume deletion program 515-2 replaces the corresponding cache area #701 and the type 702 between the data sharing volume 202 and the replication source volume 200 or replication destination volume 201 that are left last.

Because the data stored in the data sharing volume is moved to the replication source volume 200 or replication destination volume 201 that remains last in step S2806, its own data sharing cache area 204 is required to be accessed during the write or the read.

In step S2807, the volume deletion program 515-2 updates the data sharing volume 202 of the volume management table 520 and the data sharing VOL #602 of the replication source volume 200 or replication destination volume 201 that remains last. As a result of the update, the data sharing VOL #602 becomes the VOL #600 of the replication source volume 200 or replication destination volume 201 that remains last. In addition, the volume deletion program 515-2 exchanges and updates the data share volume 202 of the volume management table 520 and the last-remaining directory #604 of the replication source volume 200 or the replication destination volume 201. Step S2808 and the subsequent steps are the same as step S2207 and the subsequent steps in FIG. 22.

### Effects of Embodiments

(1) In the first embodiment, the data sharing volume 202 that shares the data of the replication source volume 200 is produced, and the data of the replication source volume 200 is transferred to the data sharing volume 202. When the replication source volume 200 or the replication destination volume 201 is deleted, the data of the cache area 203 or the data sharing cache area 204 of the deletion target volume is transferred to the data sharing volume 202, so that the deletion target volume can be deleted.
(2) In addition, in the first embodiment, the data transfer is performed when the replication source volume 200 is replicated for the first time to produce the replication destination volume 201 to construct the replication relationship between the replication source volume 200 and the replication destination volume 201. Consequently, after the replication relationship between the replication source volume 200 and the replication destination volume 201 is constructed to transfer the data, the volume operations of the replication source volume 200 and the replication destination volume 201 can be performed at arbitrary timing.
(3) In the second embodiment, when the replication source volume 200 or replication destination volume 201 that accesses the data sharing volume 202 by the volume deletion is one last logical volume, the data sharing volume 202 transfers the data to the last volume. Then, the data sharing volume 202 is deleted. Consequently, the unnecessary data sharing volume 202 can be deleted to enhance the utilization efficiency of the resource.
(4) In the first embodiment, the data is transferred and received by replacing the relationship between the data sharing cache area 204 and the logical volume in the cache area management table 521. The logical volume is any one of the replication source volume 200, the replication destination volume 201, and the data sharing volume 202. Consequently, only the data sharing cache area in which the compressed data referred to from the directory table or the mapping table is stored can be quickly replaced between the volumes.
(5) In addition, in the second embodiment, during the data transfer and reception in the cache area management table 521, the relationship with the volume is replaced by the set of the cache area 203 and the data sharing cache area 204, whereby the data is transferred and received. Consequently, a cache hit rate can be increased by taking over the cache data stored in the cache area 203 provided as the area where each volume can access the host device (server system 102).
(6) In addition, in the first embodiment, the directory table 301 is copied to the replacement destination volume of the cache area 203 before the relationship between the set of the cache area 203 and the set of the data sharing cache area 204 is replaced with the volume. Consequently, when the directory copy is performed to the directory area corresponding to the cache area replacement destination volume accompanying the replacement of the cache area, the host device can access the same data even after the cache area is replaced.
(7) In addition, in the first embodiment, even when the write is performed to the area in which the copy is completed to update the directory table 301 during the copy processing of the directory table 301, the replication is completed without re-copying the directory table 301. Consequently, even when a situation in which the volume of the copy source is written and is not the latest directory table is generated during the copy of the directory table 301, the volume replication processing can be quickly completed by not performing retry of the copy processing.
(8) In addition, in the second embodiment, when the latest directory table 301 of the target area of the I/O after the cache area 203 and the data sharing cache area 204 are replaced between the volumes is copied, the I/O processing is performed after the directory advance-copy is performed. As described above, in the volume replication processing, the latest directory table 301 is copied before the I/O at the timing of the I/O processing instead of quickly ending the directory copy processing without the retry of the directory copy processing. Consequently, even after the cache area replacement, the same data as that before the cache replace can be accessed.

The present invention is not limited to the above embodiments, but includes various modifications. For example, although only one storage system 100 in FIG. 1 is illustrated, a cluster configuration including a plurality of storage systems may be used, or the storage system may be on a cloud. The above embodiments are described in detail in order to explain the present invention in an easy-to-understand manner, but the above embodiments are not necessarily limited to the case including all the described configurations. In addition, the present invention is not limited to the deletion of the configuration, and the configuration can be replaced or added.

Some or all of the configurations, functions, processing units, processing measure, and the like may be implemented by hardware by, for example, designing an integrated circuit. In addition, the present invention can also be implemented by a program code of software that implements the functions of the embodiments. In this case, a recording medium in which the program code is recorded is provided to a computer, and a processor included in the computer reads the program code stored in the recording medium. In this case, the program code itself read from the recording medium implements the function of the embodiment, and the program code itself and the recording medium storing the program code configure the present invention. For example, a flexible disk, a CD-ROM, a DVD-ROM, a hard disk, a solid state drive (SSD), an optical disk, a magneto-optical disk, a CD-R, a magnetic tape, a non-volatile memory card, and a ROM is used as a recording medium that supplies such a program code.

In addition, the program code that implements the functions described in the embodiments can be mounted by a wide range of programs or script languages such as assembler, C/C++, perl, Shell, PHP, and Java (registered trademark).

In the embodiments, the control lines and the information lines indicate what is considered to be necessary for the description, but do not necessarily indicate all the control lines and the information lines on the product. All the configurations may be connected to each other.

What is claimed is:

1. A storage system providing a plurality of logical volumes comprising a plurality of controllers, wherein
each of the logical volumes includes a first cache area that stores data and a second cache area that compresses and stores the data stored in the first cache area, and
when the controller replicates the logical volume,
data stored in the second cache area of a replication source logical volume is moved to the second cache area of a data sharing logical volume, and data in the first cache area of the replication source logical volume is associated with the data moved to the second cache area of the data sharing logical volume, and
a storage area of the first cache area of a replication destination logical volume that is a replication of the replication source logical volume is associated with a storage area that is the second cache area of the data sharing logical volume and stores the data.

2. The storage system according to claim 1, wherein the controller produces the data sharing logical volume when the data sharing logical volume does not exist for the replication source logical volume.

3. The storage system according to claim 1, wherein, when data is written in the first cache area of the replication source logical volume after production of the replication destination logical volume, the data is compressed and stored in the second cache area of the data sharing logical volume without being associated with the replication destination logical volume.

4. The storage system according to claim 3, wherein, when the data write in the first cache area of the replication source logical volume after production of the replication destination logical volume is write that updates data, data after update is stored while data before update is left.

5. The storage system according to claim 4, wherein, when the logical volume that accesses the data sharing logical volume becomes only one replication destination logical volume by deleting the replication source logical volume, the controller moves data stored in the second cache area of the data sharing logical volume to the replication destination logical volume and delete the data sharing logical volume.

6. The storage system according to claim 5, wherein data of the second cache area of the data sharing logical volume that is referred to from only the replication source logical volume to be deleted is deleted.

7. The storage system according to claim 1, wherein the controller performs data movement between the second cache area of the logical volume and the second cache area of the data sharing logical volume by replacing the second cache area of the logical volume and the second cache area of the data sharing logical volume, and replaces also directory information indicating a relationship with the first cache area of the logical volume associated with the second cache area when the second cache area is replaced.

8. The storage system according to claim 7, wherein data input and output to and from the second cache area is stopped when the second cache area and the directory information are replaced.

9. A data replication method in a storage system including a plurality of controllers and providing a plurality of logical volumes, each of the logical volumes including a first cache area that stores data and a second cache area that compresses and stores the data stored in the first cache area, the data replication method comprising:
when the controller replicates the logical volume,
processing of moving data stored in the second cache area of a replication source logical volume to the second cache area of a data sharing logical volume and associating data in the first cache area of the replication source logical volume with the data moved to the second cache area of the data sharing logical volume; and
processing of associating a storage area of the first cache area of a replication destination logical volume that is a replication of the replication source logical volume with a storage area that is the second cache area of the data sharing logical volume and stores the data.
